(19) United States
(12) Patent Application Publication
(10) Pub. No.: US 2016/0208157 A1
(43) Pub. Date: Jul. 21, 2016

(54) CONSOLIDATION COMPOSITION INCLUDING POLYHEDRAL OLIGOMERIC SILSESQUIOXANE AND METHODS OF USING THE SAME

(71) Applicant: HALLIBURTON ENERGY SERVICES, INC., Houston, TX (US)

(72) Inventors: Loan K. Vo, Houston, TX (US); Bradley J. Sparks, Richmond, TX (US); Philip D. Nguyen, Houston, TX (US)

(73) Assignee: Halliburton Energy Services, Inc., Houston, TX (US)

(21) Appl. No.: 14/914,438

(22) PCT Filed: Dec. 11, 2013
(86) PCT No.: PCT/US2013/074391

§ 371 Date: Feb. 25, 2016

(51) Int. Cl. C09K 8/575; E21B 43/26; E21B 43/267; C09K 8/80

(52) U.S. Cl. CPC C09K 8/5756; C09K 8/80; E21B 43/26; E21B 43/267

(57) ABSTRACT

Various embodiments disclosed relate to a curable composition for consolidation of particulates in a subterranean formation and methods of using the same. In various embodiments, the present invention provides a method of treating a subterranean formation. The method can include obtaining or providing a curable composition including a polyhedral oligomeric silsesquioxane (POSS) comprising at least one curable or curing group. The composition also includes an agent curably reactive with the curable or curing groups. The method can also include placing the composition in a subterranean formation downhole.

### BACKGROUND OF THE INVENTION

The presence of the particulate matter, such as sand, in produced fluids from hydrocarbon wells can be problematic. For example, particulates can abrade pumping and other production equipment and reduce the fluid production capabilities of the producing zones. Hydrocarbon wells are often located in subterranean zones that contain unconsolidated particulate matter that can migrate out of the well along with oil, gas, water, or other fluids produced by the well. The placing of proppant downhole during hydraulic fracturing operations can result in unconsolidated proppant that can become entrained with produced fluids.

Production of water from oil and gas wells constitutes a major problem and expense. When the hydrocarbon-producing formation in which an oil or gas well is completed contains layers of water and hydrocarbons or when there are water-producing zones near the hydrocarbon-producing formation, the higher mobility of the water often allows it to flow into the wellbore. In the production of such wells, the ratios of water to hydrocarbons recovered can become so high that the cost of producing the water, separating it from the hydrocarbons, and disposing of it represents a significant economic loss. Downhole water control treatments to mitigate production of water and downhole treatments to consolidate particulate matter are performed as at least two separate treatments, each requiring different treatment compositions. The transportation, preparation, and application downhole of each composition is inconvenient, and requires both time and economic expenditure.

The bonding between particulates provided by current consolidation technologies is brittle and has little resilience toward stress effects that can occur downhole. The bonded particulate material is generally not hydrophobic and requires additional treatments with a different composition to achieve water control. Current compositions for providing consolidation do not efficiently coat and bond to proppant particles—generally treatment with an adhesion enhancer such as a coupling agent is required to provide strong bonding between the proppant and the consolidation composition.

### SUMMARY OF THE INVENTION

In various embodiments, the present invention provides a method of treating a subterranean formation. The method can include obtaining or providing a curable composition. The curable composition can include a polyhedral oligomeric silsesquioxane (POSS) including at least one curable or curing group. The curable composition can include an agent curably reactive with the curable or curing groups. The method can include placing the composition in a subterranean formation downhole.

In various embodiments, the present invention provides a method of treating a subterranean formation. The method can include obtaining or providing a curable composition including a polyhedral oligomeric silsesquioxane (POSS) including at least one curable group, the POSS having a structure selected from the group consisting of

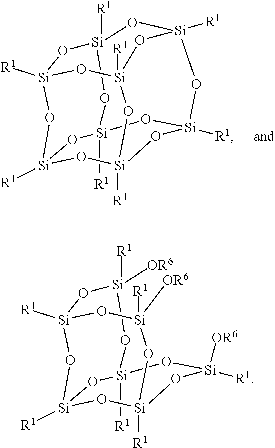

The variable R¹ at each occurrence is independently selected from the group consisting of —R², -L-R², and -L-R³—R⁴. The variable R² at each occurrence is independently selected from the group consisting of (C₁-C₃₀)hydrocarbyl, (C₁-C₃₀)hydrocarbylene-CG, and -CG, wherein each (C₁-C₃₀)hydrocarbyl and (C₁-C₃₀)hydrocarbylene is independently substituted or unsubstituted and is interrupted or terminated by 0, 1, 2, or 3 S or O atoms. The variable R³ at each occurrence is independently -(ethyleneoxy)ₙ- wherein n is about 1 to about 50. The variable R⁴ at each occurrence is independently selected from the group consisting of —H and R². The variable L at each occurrence is independently selected from a bond, —O—, —O—SiR¹₂—, —(O—SiR¹₂)ₘ—, —O—SiR¹₂—O—, wherein m is about 2 to about 1,000. The variable R⁶ at each occurrence is independently selected from the group consisting of —H and R¹. At least one R¹ includes CG, the at least one curable group, wherein the at least one curable group is selected from the group consisting of oxirane, isocyanate, (C₂-C₈)alkynyl, (C₂-C₈)alkenyl, ethylenyl, and aldehyde. The curable composition also includes a curing agent curably reactive with the curable groups. The method includes placing the composition in a subterranean formation downhole. The method also includes allowing the composition to cure.

In various embodiments, the present invention provides a curable composition for treatment of a subterranean formation. The composition includes a polyhedral oligomeric silsesquioxane (POSS) including at least one curable or curing groups. The composition also includes an agent curably reactive with the curable or curing groups. In some embodiments, the composition can further include a proppant or gravel.

In various embodiments, the present invention provides a method of preparing a composition for treatment of a subterranean formation. The method can include forming a curable composition including a polyhedral oligomeric silsesquioxane (POSS) including at least one curable or curing group. The composition also includes an agent curably reactive with the curable or curing groups.

Various embodiments of the present invention provide certain advantages over other compositions and methods for consolidation, at least some of which are unexpected. In various embodiments, the bonding provided between particulates by the cured product of the composition is more flexible and more resilient toward stress effects that can occur downhole. The increased flexibility and resiliency can increase the effectiveness of the consolidation and provide production liquids having reduced particulate content for longer periods of time and at a higher rate. In various embodiments, the cured product of the curable composition is more hydrophobic than other cured compositions, providing better water control than other consolidation treatments, and can help to avoid or lessen separate water control treatments which can be time consuming and require transportation of a separate composition to the work site.

In various embodiments the curable composition or the cured product of the composition can adhere more strongly to particulates such as proppant without the use of an adhesion enhancer such as a coupling agent. By avoiding a separate treatment step with an adhesion enhancer, a pre-coated proppant having stronger bonds to the consolidation composition can be easier and cheaper to make, or a stronger bond can be provided between particulates that are located downhole at the time the particles are combined with the composition. In some embodiments, the POSS can agglomerate at interfaces more readily than other curable materials, making it more effective as a wet-coating agent.

In various embodiments, the properties of the curable composition can be more easily tuned and customized by variation of the POSS structure or by variation of the composition, such as the melting point, solubility (e.g., hydrophilicity and hydrophobicity of the curable composition and of the cured product), speed of the cure under various conditions, and properties of the cured product like strength, stiffness, and flexibility. In various embodiments, by applying the POSS as a solid, the curable composition can respond to desired temperature and pressure conditions more effectively than other curable compositions, such as by melting, thereby initiating the curing reaction.

### BRIEF DESCRIPTION OF THE FIGURES

The drawings illustrate generally, by way of example, but not by way of limitation, various embodiments discussed in the present document.

FIG. 1 illustrates a solid polyhedral oligomeric silsesquioxane between proppant particles coated with a curably reactive agent, in accordance with various embodiments.

FIG. 2 illustrates a drilling assembly, in accordance with various embodiments.

FIG. 3 illustrates a system or apparatus for delivering a composition downhole, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Selected substituents within the compounds described herein are present to a recursive degree. In this context, “recursive substituent” means that a substituent may recite another instance of itself or of another substituent that itself recites the first substituent. Recursive substituents are an intended aspect of the disclosed subject matter. Because of the recursive nature of such substituents, theoretically, a large number may be present in any given claim. One of ordinary skill in the art of organic chemistry understands that the total number of such substituents is reasonably limited by the desired properties of the compound intended. Such properties include, by way of example and not limitation, physical properties such as molecular weight, solubility, and practical properties such as ease of synthesis. Recursive substituents can call back on themselves any suitable number of times, such as about 1 time, about 2 times, 3, 4, 5, 6, 7, 8, 9, 10, 15, 20, 30, 50, 100, 200, 300, 400, 500, 750, 1000, 1500, 2000, 3000, 4000, 5000, 10,000, 15,000, 20,000, 30,000, 50,000, 100,000, 200,000, 500,000, 750,000, or about 1,000,000 times or more.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen (in examples that include other carbon atoms) or a carbon-based moiety, and wherein the carbon-based moiety can itself be further substituted.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxyl groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups. Non-limiting examples of substituents J that can be bonded to a substituted carbon (or other) atom include F, Cl, Br, I, OR, OC(O)N(R′)₂, CN, NO, NO₂, ONO₂, azido, CF₃, OCF₃, R′, O (oxo), S (thiono), C(O), S(O), methylenedioxy, ethylenedioxy, N(R)₂, SR, SOR, SO₂R′, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen or a carbon-based moiety, and wherein the carbon-based moiety can itself be further substituted; for example, wherein R can be hydrogen, alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl or R can be independently mono- or multi-substituted with J; or wherein two R groups bonded to a nitrogen atom or to adjacent nitrogen atoms can together with the nitrogen atom or atoms form a heterocyclyl, which can be mono- or independently multi-substituted with J.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —CC(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms within the meaning here. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “heterocyclyl” as used herein refers to aromatic and non-aromatic ring compounds containing 3 or more ring members, of which, one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth. Likewise a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a mono alkylamino, dialkylamino, and trialkylamino group.

The terms “halo,” “halogen,” or “halide” group, as used herein, by themselves or as part of another substituent, mean, unless otherwise stated, a fluorine, chlorine, bromine, or iodine atom.

The term “hydrocarbon” as used herein refers to a functional group or molecule that includes carbon and hydrogen atoms. The term can also refer to a functional group or molecule that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof.

The term “solvent” as used herein refers to a liquid that can dissolve a solid, liquid, or gas. Nonlimiting examples of solvents are silicones, organic compounds, water, alcohols, ionic liquids, and supercritical fluids.

The term “number-average molecular weight” as used herein refers to the ordinary arithmetic mean of the molecular weight of individual molecules in a sample. It is defined as the total weight of all molecules in a sample divided by the total number of molecules in the sample. Experimentally, the number-average molecular weight (Mₙ) is determined by analyzing a sample divided into molecular weight fractions of species i having n, molecules of molecular weight Mᵢ through the formula Mₙ=ΣMᵢnᵢ/Σnᵢ. The number-average molecular weight can be measured by a variety of well-known methods including gel permeation chromatography, spectroscopic end group analysis, and osmometry. If unspecified, molecular weights of polymers given herein are number-average molecular weights.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

The term “room temperature” as used herein refers to a temperature of about 15° C. to 28° C.

The term “standard temperature and pressure” as used herein refers to 20° C. and 101 kPa.

As used herein, “degree of polymerization” is the number of repeating units in a polymer.

As used herein, the term “polymer” refers to a molecule having at least one repeating unit and can include copolymers.

The term “copolymer” as used herein refers to a polymer that includes at least two different monomers. A copolymer can include any suitable number of monomers.

The term “downhole” as used herein refers to under the surface of the earth, such as a location within or fluidly connected to a wellbore.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packing fluid” refers to fluids or slurries that can be placed in the annular region of a well between tubing and outer casing above a packer. In various examples, the packing fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore, or vice-versa. A flow pathway can include at least one of a hydraulic fracture, a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

### Method of Treating a Subterranean Formation.

Various embodiments of the present invention provide a new consolidation composition and methods of using the same for treatment of a subterranean formation. Embodiments of the methods including application of the composition during well completions, including primary proppant treatments for immobilizing proppant particulates (e.g., hydraulic fracturing, gravel packing, and frac-packing), remedial proppant/gravel treatments, near-wellbore formation sand consolidation treatments for sand control, consolidating-while-drilling target intervals, and plugging-and-abandonment of wellbores in subterranean formations.

The method of treating a subterranean formation includes obtaining or providing a composition including a polyhedral oligomeric silsesquioxane (POSS) comprising at least one curable or curing group, and an agent curably reactive with the curable or curing groups. The obtaining or providing of the composition can occur at any suitable time and at any suitable location. The obtaining or providing of the composition can occur above the surface. The obtaining or providing of the composition can occur downhole. The method also includes placing the composition in a subterranean formation. The placing of the composition in the subterranean formation can include contacting the composition and any suitable part of the subterranean formation, or contacting the composition and a subterranean material downhole, such as any suitable subterranean material. The subterranean formation can be any suitable subterranean formation. In some examples, the placing of the composition in the subterranean formation includes contacting the composition with or placing the composition in at least one of a fracture, at least a part of an area surrounding a fracture, a flow pathway, an area surrounding a flow pathway, and an area desired to be fractured. The placing of the composition in the subterranean formation can be any suitable placing and can include any suitable contacting between the subterranean formation and the composition. The placing of the composition in the subterranean formation can include at least partially depositing the composition in a fracture, flow pathway, or area surrounding the same.

The method can include hydraulic fracturing, such as a method of hydraulic fracturing to generate a fracture or flow pathway. The placing of the composition in the subterranean formation or the contacting of the subterranean formation and the hydraulic fracturing can occur at any time with respect to one another; for example, the hydraulic fracturing can occur at least one of before, during, and after the contacting or placing. In some embodiments, the contacting or placing occurs during the hydraulic fracturing, such as during any suitable stage of the hydraulic fracturing, such as during a slurry stage of the fracturing (e.g., injection of viscous fluid with proppant). The method can include performing a stimulation treatment at least one of before, during, and after placing the composition in the subterranean formation in the fracture, flow pathway, or area surrounding the same. The stimulation treatment can be, for example, at least one of perforating, acidizing, injecting of cleaning fluids, propellant stimulation, and hydraulic fracturing. In some embodiments, the stimulation treatment at least partially generates a fracture or flow pathway where the composition is placed or contacted, or the composition is placed or contacted to an area surrounding the generated fracture or flow pathway.

The method can include combining the POSS and curably reactive agent with a proppant or gravel above-surface or downhole. For example, in some embodiments, the composition further includes at least one of proppant and gravel. In some embodiments, the method includes placing proppant in the subterranean formation prior to placing the composition in the subterranean formation. The method can be a method of remedial proppant or gravel treatment. In some embodiments, the method includes placing proppant in the subterranean formation after placing the composition in the subterranean formation. The method can include coating a mixture including the curable resin and the curing agent on the proppant or gravel.

The proppant or gravel can be any suitable proppant or gravel. A proppant is a material that keeps an induced hydraulic fracture at least partially open during or after a fracturing treatment. Examples of proppants can include sand, gravel, glass beads, polymer beads, ground products from shells and seeds such as walnut hulls, and manmade materials such as ceramic proppant, bauxite, tetrafluoroethylene materials (e.g., TEFLON™ available from DuPont), fruit pit materials, processed wood, composite particulates prepared from a binder and fine grade particulates such as silica, alumina, fumed silica, carbon black, graphite, mica, titanium dioxide, meta-silicate, calcium silicate, kaolin, talc, zirconia, boron, fly ash, hollow glass microspheres, and solid glass, or mixtures thereof. In some embodiments, proppant can have an average particle size, wherein particle size is the largest dimension of a particle, of about 0.001 mm to about 3 mm, about 0.15 mm to about 2.5 mm, about 0.25 mm to about 0.43 mm, about 0.43 mm to about 0.85 mm, about 0.85 mm to about 1.18 mm, about 1.18 mm to about 1.70 mm, or about 1.70 to about 2.36 mm. In some embodiments, the proppant can have a distribution of particle sizes clustering around multiple averages, such as one, two, three, or four different average particle sizes. The proppant or gravel can form any suitable wt % of the composition, such as about 1 wt % to about 90 wt %, or about 5 wt % to about 70 wt %, or about 1 wt % or less, or about 2, 3, 4, 5, 10, 15, 20, 25, 30, 35, 40, 45, 50, 55, 60, 65, 70, 75, 80, 85 wt %, or about 90 wt % or more.

The method can include allowing the composition to at least partially cure, such as by allowing the composition time under suitable conditions for a chemical reaction between the curing agent and the amine-curable resin to occur. The curing occurs at least in part downhole. Some portions of the curing can occur at the surface before placing the composition in the subterranean formation, and during transport of the composition downhole, but curing predominantly occurs downhole.

In one embodiment, the present invention provides a method of treating proppant on the fly during the hydraulic fracturing treatment or screenless frac-pack treatment. The method can include mixing of the POSS and the curably reactive agent to form a single homogeneous mixture. The method can include coating of the mixture on a proppant while the proppant is being mixed in a fracturing carrier fluid. The method can include placing the proppant slurry in a subterranean formation, such as in a generated fracture located therein. The method can include allowing proppant slurry to undergo a curing reaction and transform into a competent, consolidated, permeable proppant pack for controlling proppant flowback during well production.

In some embodiments, a single component curable composition is provided including the POSS and the curably reactive agent. The composition can optionally include a silane coupling agent, a carrier fluid, and a surfactant for facilitating coating on a particulate substrate. In some embodiments, obtaining or providing the composition includes obtaining or providing Part I, wherein Part I includes the POSS. Obtaining or providing the composition can also include obtaining or providing Part II, wherein Part II includes the curing agent. Obtaining or providing the composition can include mixing Part I and Part II. In one embodiment, a two-component resin system is provided including Part I, a liquid component including the POSS suspended or dissolved in a liquid carrier fluid and Part II, a liquid curably reactive agent component including a curing agent. Part II can also optionally include a silane coupling agent, a surfactant for facilitating coating on a particulate substrate, and a liquid carrier fluid.

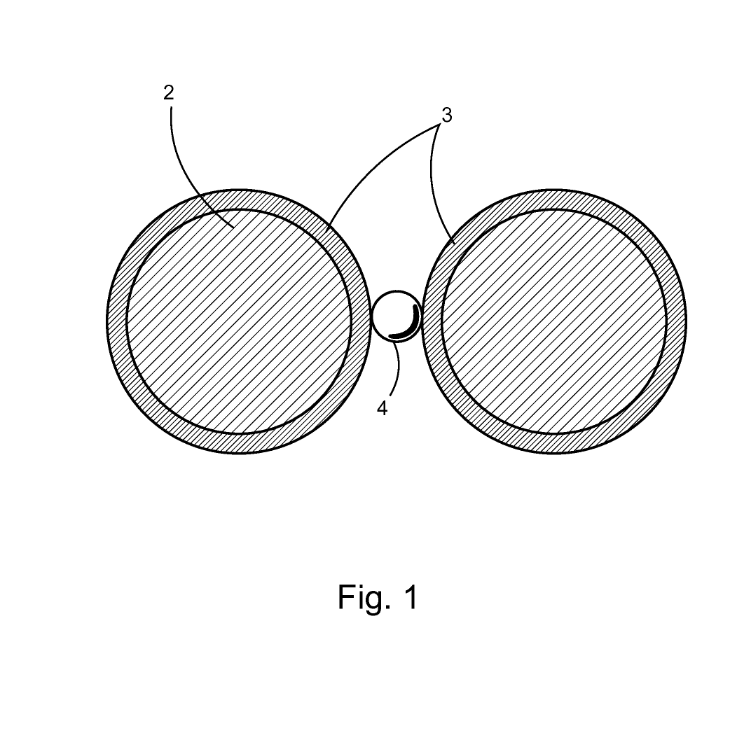

The POSS can be in any suitable form in the composition. In some embodiments, the POSS is in a liquid form or is substantially dissolved in the composition. In some embodiments, the POSS is in a substantially solid form, e.g., not dissolved and not liquid. In some embodiments, the composition can include a solid POSS and a proppant or gravel, wherein the proppant or gravel has a coating thereon that includes the curably reactive agent. An example embodiment is shown in FIG. 1, showing proppant 2 coated with curably reactive agent 3 and solid POSS 4. The method can include allowing conditions downhole (e.g., temperature and pressure) to cause the solid POSS 4 to melt, thereby activating a curing reaction between the POSS 4 and the curably reactive agent 3. In one embodiment, the present invention provides a method of treating proppant on the fly during the hydraulic fracturing treatment or screenless frac-pack treatment. The method can include providing curably reactive agent. The curably reactive agent can optionally be mixed with a surfactant and a silane coupling agent. The curably reactive agent and other components can be dry coated on a proppant. The resulting coated proppant can be added to the fracturing fluid while mixing. Solid particulates of POSS can be added to the fracturing fluid as a dry additive while mixing. The proppant slurry can be placed in subterranean formation, such as in a generated fracture located therein. The formation can be allowed to close and formation temperature and pressure can melt the resin solids between proppant grains, activating the curing process and thereby generating competent, consolidated, permeable proppant pack for controlling proppant flowback during well production.

In some embodiments, the method is a method of near-wellbore treatment during a drilling operation. The method can be a method of near-wellbore formation sand consolidation treatments for sand control. The method can be a method of consolidating while drilling target intervals. The method can be a method of plugging-and-abandonment of wellbores in subterranean formations

### Polyhedral Oligomeric Silsesquioxane (POSS).

The curable composition includes a POSS that includes at least one curable group or at least one curing group. The curable composition can include one type of POSS, or multiple different POSS. A POSS including a curable group is curably reactive with an agent curably reactive with the curable group, e.g., a curing agent. A POSS including a curing group can function as a curing agent, and is curably reactive with an agent curably reactive with the curing group, e.g., a curable agent such as a curable resin.

The POSS is a polyorganosiloxane with a polyhedral chemical structure. The POSS can have the average unit formula [R¹SiO_{3/2}], wherein at least one R¹SiO_{3/2} unit in the POSS includes a curable or curing group. The repeating unit of the POSS can have the structure

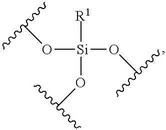

wherein each silicon-bonded oxygen is bonded to another silicon atom, a hydrogen atom (e.g., silanol), or to an independently selected R¹ as defined herein. The POSS can have a total number of [R¹SiO_{3/2}] units selected from the group consisting of 6, 7, 8, 9, 10, 11, and 12. The POSS can be any suitable POSS. The POSS can be a partially- or fully-caged POSS. Each corner of the POSS polyhedron can be occupied by a silicon atom, and each edge of the polyhedron can be formed by an Si—O—Si unit. The POSS can include at least three faces, with each face having a different plane, and with each face being defined as four interconnected R¹SiO_{3/2} units, having the structure

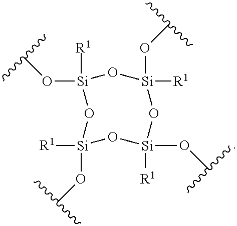

In some embodiments, the POSS can have a structure selected from the group consisting of

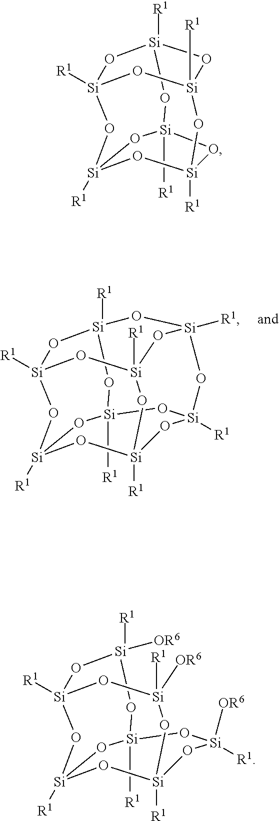

The variable R¹ at each occurrence can be independently selected from the group consisting of —R², -L-R², and -L-R³—R⁴. The variable R² at each occurrence can be independently selected from the group consisting of (C₁-C₃₀)hydrocarbyl, (C₁-C₃₀)hydrocarbylene-CG, and -CG, wherein each (C₁-C₃₀)hydrocarbyl and (C₁-C₃₀)hydrocarbylene is independently substituted or unsubstituted and is interrupted or terminated by 0, 1, 2, or 3 substituted or unsubstituted S, O, P, or N atoms (wherein an unsubstituted atom designates, e.g., the S, O, P, or N atom having no substituents or having —H thereon). The variable R³ at each occurrence can be independently —((C₂-C₈)alkyloxy)ₙ- wherein each alkyl group is independently substituted or unsubstituted and n is about 1 to about 1,000. The variable R⁴ at each occurrence can be independently selected from the group consisting of —H and R². The variable L at each occurrence can be independently selected from a bond, —O—, —O—SiR¹₂—, —(O—SiR¹₂)ₘ—, —O—SiR¹₂—O—. The variable m can be about 2 to about 1,000. At each occurrence R⁶ can be independently selected from the group consisting of —H and R¹. At least one R¹ in the POSS includes CG, the at least one curable group or curing group.

In POSS that include at least one curable functional group, the curable functional group can be any suitable curable functional group, such as oxirane, isocyanate, (C₂-C₈)alkynyl, (C₂-C₈)alkenyl, ethyleneyl, or aldehyde. The POSS can include one type of curable functional group, or multiple types of curable functional groups.

In POSS that include at least one curing functional group, the curing functional group can be any suitable curing functional group, such as —NH₂, —NHR⁵, —SH, and —OH, wherein R⁵ is a C₁-C₈ hydrocarbyl. The curing functional group can be —C(O)—OH, —S(O)(O)—OH, or —P(O)(OH)₂. The POSS can include one type of curing functional group, or multiple types of curing functional groups.

The variable L at each occurrence can be independently selected from a bond, —O—, —O—SiR¹₂—, —(O—SiR¹₂)ₘ—, —O—SiR¹₂—O—. In some embodiments, at least one L in the POSS structure is —O—. At least one L can be —OSi((C₁-C₅)alkyl)₂-. At least one L can be —OSi(CH₃)₂—.

The variable R² at each occurrence can be independently selected from the group consisting of (C₁-C₃₀)hydrocarbyl, (C₁-C₃₀)hydrocarbylene-CG, and -CG, wherein each (C₁-C₃₀)hydrocarbyl and (C₁-C₃₀)hydrocarbylene is independently substituted or unsubstituted and is interrupted or terminated by 0, 1, 2, or 3 substituted or unsubstituted S, O, P, or N atoms (wherein an unsubstituted atom designates, e.g., the S, O, P, or N atom having no substituents or having —H thereon). In some embodiments, at least one R² in the POSS structure is (C₁-C₃₀)alkyl interrupted or terminated by 0, 1, 2, or 3 substituted or unsubstituted S, O, P, or N atoms. At least one R² can be (C₁-C₈)alkyl-CG. At least one R² can be (C₁-C₈)alkyl. At least one R² can be -CG.

The variable R³ at each occurrence can be independently —((C₂-C₈)alkyloxy)ₙ- wherein each alkyl group is independently substituted or unsubstituted and n is about 1 to about 1,000. In some embodiments, at least one R³ in the POSS structure is -(ethyleneoxy)ₙ- wherein n is about 1 to about 50.

In some embodiments, at least one R¹ in the POSS structure is —(C₁-C₈)alkyl. At least one R¹ can be —(C₁-C₈)alkyl-CG. At least one R¹ can be —(C₁-C₈)alkyloxy(C₁-C₁₀)alkyl-CG. At least one R¹ can be —(C₁-C₈)alkyloxy(C₁-C₁₀)alkyloxirane. At least one R¹ can be —O—Si(CH₃)₂(C₁-C₈)alkyloxy(C₁-C₁₀)alkyl-CG. At least one R¹ can be —O—Si(CH₃)₂(C₁-C₈)alkyloxy(C₁-C₁₀)alkyloxirane. At least one R¹ can be —O-(ethyleneoxy)ₘ-(C₁-C₁₀)alkyl-CG m is 1 to 1,000. At least one R¹ can be —O-(ethyleneoxy)ₘ-(C₁-C₁₀)alkyloxirane m is 1 to 50. At least one R¹ can be —O—Si(CH₃)₂—(CH₂)₃—O-glycidyl. For example, the POSS can be a fully caged cubic POSS (having eight R¹SiO_{3/2} units) with each of the eight R¹ variables equal to —O—Si(CH₃)₂—(CH₂)₃—O-glycidyl. At least one R¹ can be —O—Si(CH₃)₂—(CH₂)₂-epoxycyclohexyl. For example, the POSS can be a fully caged cubic POSS (having eight R¹SiO_{3/2} units) with each of the eight R¹ variables equal to —O—Si(CH₃)₂—(CH₂)₂-3,4-epoxycyclohexyl. In another example, the POSS can be a partially caged cubic POSS having the following structure

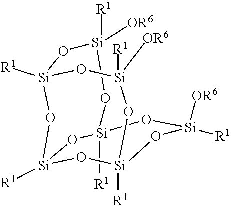

with seven R¹SiO_{3/2} units with all three of the R⁶ variables equal to —Si(CH₃)₂—(CH₂)₃—O-glycidyl and with all seven R¹ equal to isobutyl. In another example, the POSS has the partially caged cubic structure having seven R¹SiO_{3/2} units, with all three of the R⁶ variables equal to —H and with all seven of the R¹ variables equal to —O—(CH₂)₂—O-glycidyl.

In various embodiments, the silanol groups of a half-caged POSS can form bonds with particulates, such as sand or other Si-containing materials, forming a strong bond.

### Curably Reactive Agent.

The curable composition can include an agent curably reactive with the curable or curing groups. The curable composition can include one type of curably reactive agent, or multiple different curably reactive agents. In some examples, the POSS includes curable groups and the agent is a curing agent having curing functional groups thereon that are curably reactive with the curable groups on the POSS. In some embodiments, the POSS includes curing groups and the agent is a curable agent having curable functional groups thereon that are curably reactive with the curing groups on the POSS. The curably reactive agent can be present in the composition in any suitable wt %, such as about 0.001 wt % to about 50 wt % of the curable composition, or about 0.01 wt % to about 30 wt %, or about 0.001 wt % or less, or about 0.01 wt %, 0.1, 1, 2, 3, 4, 5, 10, 15, 20, 25, 30, 35, 40, 45, or about 50 wt % or more.

In some embodiments, the POSS includes curable groups, and the curably reactive agent is a curing agent. The curing agent can be any suitable curing agent having functional groups that are curably reactive with the curing groups on the POSS. For example, the curing agent can be an amine, an aromatic amine, an aliphatic amine, a cyclo-aliphatic amine, a polyamine, a polyimine, a polyacid, a (C₃-C₆₀)dicarboxylic acid (e.g., a C₃₆ diacid), a (C₃-C₆₀)tricarboxylic acid, a (C₃-C₆₀)fatty acid, a fatty acid derivative, maleic anhydride, a maleic anhydride derivative, acrylic acid, an acrylic acid derivative, piperidine, triethylamine, benzyldimethylamine, N,N-dimethylaminopyridine, 2-(N,N-dimethylaminomethyl)phenol, tris(dimethylaminomethyl)phenol, N-2-(aminoethyl)-3-aminopropyltrimethoxysilane, 3-glycidoxypropyltrimethoxysilane, n-beta-(aminoethyl)-gamma-aminopropyl trimethoxysilane, n-beta-(aminoethyl)-gamma-aminopropyl trimethoxysilane, and combinations thereof. The curing agent can be any suitable amount of the curable composition, such as about 0.001 wt % to about 50 wt % of the curable composition, about 0.01 wt % to about 20 wt %, or about 0.001 wt % or less, or about 0.01 wt %, 0.1, 1, 2, 3, 4, 5, 10, 15, 20, 25, 30, 35, 40, 45, or about 50 wt % or more of the curable composition.

In some embodiments, the POSS includes curing groups, wherein the curably reactive agent is a curable agent. The curable agent can be any suitable agent, such as a curable resin, such as a urethane, a natural resin, an epoxy-based resin, a furan-based resin, an aldehyde resin, bisphenol A diglycidyl ether resin, butoxymethyl butyl glycidyl ether resin, bisphenol A-epichlorohydrin resin, a bisphenol F resin, an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer or derivative thereof; an acrylic acid/acrylamidomethylpropane sulfonate copolymer, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, an epoxide, or furfuraldehyde. The curable agent can form any suitable wt % of the composition, such as about 0.001 wt % to about 50 wt % of the curable composition, about 0.01 wt % to about 30 wt %, about 0.001 wt % or less, or about 0.01 wt %, 0.1, 1, 2, 3, 4, 5, 10, 15, 20, 25, 30, 35, 40, 45, or about 50 wt % of the curable composition.

### Other Components.

The composition can include any suitable additional components in any suitable concentration, such that the method can be carried out as described herein.

In some embodiments, the composition further includes a catalyst or an accelerator, which can catalyze or accelerate the rate of the curing reaction. The catalyst or accelerator can be any suitable catalyst or accelerator, such as a base, such as a weak base, such as an amine, such as Hunig's base (diisopropylethylamine) or a tri(C₁-C₈)alkylamine such as triethylamine. Any suitable amount of the composition can be the catalyst or accelerator, such as about 0.001 wt % to about 5 wt %, or about 0.001 wt % or less, or about 0.01 wt %, 0.1 wt %, 1, 2, 3, 4, or about 5 wt % or more.

In some embodiments, the composition further includes a tackifier. The tackifier can be any suitable tackifier, and can be curable or non-curable. For example, the tackifier can be In some embodiments, the tackifier can be at least one of a shellac, a polyamide, a silyl-modified polyamide, a polyester, a polycarbonate, a polycarbamate, a urethane, a natural resin, an epoxy-based resin, a furan-based resin, a phenolic-based resin, a urea-aldehyde resin, and a phenol/phenol formaldehyde/furfuryl alcohol resin. In some embodiments, the tackifier can be at least one of bisphenol A diglycidyl ether resin, butoxymethyl butyl glycidyl ether resin, bisphenol A-epichlorohydrin resin, and bisphenol F resin. In some embodiments, the tackifier can be at least one of an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer or derivative thereof, and an acrylic acid/acrylamidomethylpropane sulfonate copolymer. In some embodiments, the tackifier can include at least one of a trimer acid, a fatty acid, a fatty acid-derivative, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, citric acid, an epoxide, furfuraldehyde, an aldehyde condensate, a silyl-modified polyamide, and a condensation reaction product of a polyacid and a polyamine. In some embodiments, the tackifier can be an amine-containing polymer. In some embodiments, the tackifier can be hydrophobically-modified. In some embodiments, the tackifier can include at least one of a polyamine (e.g., spermidine and spermine), a polyimine (e.g., poly(ethylene imine) and poly(propylene imine)), a polyamide, poly(2-(N,N-dimethylamino)ethyl methacrylate), poly(2-(N,N-diethylamino)ethyl methacrylate), poly(vinyl imidazole), and a copolymer comprising monomers of at least one of the foregoing and monomers of at least one non-amine-containing polymer such as of at least one of polyethylene, polypropylene, polyethylene oxide, polypropylene oxide, polyvinylpyridine, polyacrylic acid, polyacrylate, and polymethacrylate. The hydrophobic modification can be any suitable hydrophobic modification, such as at least one C₄-C₃₀ hydrocarbyl comprising at least one of a straight chain, a branched chain, an unsaturated C—C bond, an aryl group, and any combination thereof. The tackifier can be any suitable wt % of the composition, such as about 0.001 wt % to about 50 wt %, about 0.01 wt % to about 30 wt %, or about 0.001 wt % or less, or about 0.01 wt %, 0.1, 1, 2, 3, 4, 5, 10, 15, 20, 25, 30, 35, 40, 45, or about 50 wt % or more.

In some embodiments, the composition can further include a second curing agent. In some embodiments, a composition including a second curing agent can further include another curing agent (e.g., a first curing agent), while in other embodiments the composition only includes the second curing agent and includes no further curing agent. In some examples, the second curing agent can cure a tackifier in the composition, the POSS, another curable material, or any combination thereof. The second curing agent can be any suitable curing agent. For example, the second curing agent can include at least one of an amine, an aromatic amine, an aliphatic amine, a cyclo-aliphatic amine, polyamines, amides, polyamides, piperidine, triethylamine, benzyldimethylamine, N,N-dimethylaminopyridine, 2-(N,N-dimethylaminomethyl)phenol, tris(dimethylaminomethyl)phenol, N-2-(aminoethyl)-3-aminopropyltrimethoxysilane, 3-glycidoxypropyltrimethoxysilane, n-beta-(aminoethyl)-gamma-aminopropyl trimethoxysilane, n-beta-(aminoethyl)-gamma-aminopropyl trimethoxysilane, piperazine, derivatives of piperazine (e.g., aminoethylpiperazine), pyrrole, imidazole, pyrazole, pyridine, pyrazine, pyrimidine, pyridazine, indolizine, isoindole, indole, indazole, purine, quinolizine, quinoline, isoquinoline, phthalazine, naphthyridine, quinoxaline, quinazoline, carbazole, carbazole, phenanthridine, acridine, phenathroline, phenazine, imidazolidine, phenoxazine, cinnoline, pyrrolidine, pyrroline, imidazoline, piperidine, indoline, isoindoline, quinuclindine, morpholine, azocine, azepine, azepine, 1,3,5-triazine, thiazole, pteridine, dihydroquinoline, hexa methylene imine, indazole, polyamines, amides, polyamides, 2-ethyl-4-methyl imidazole, 1,1,3-trichlorotrifluoroacetone, and combinations thereof. The second curing agent can form any suitable wt % of the composition, such as about 0.001 wt % to about 50 wt %, about 0.01 wt % to about 20 wt %, or about 0.001 wt % or less, or about 0.01 wt %, 1, 2, 3, 4, 5, 10, 15, 20, 25, 30, 35, 40, 45, or about 50 wt % or more.

In some embodiments, the composition can further include a carrier fluid. The composition can include any suitable carrier fluid, such as at least one of an aqueous liquid, and organic liquid, and an oil. The carrier fluid can be any suitable wt % of the composition, such as about 5 wt % to about 95 wt %, about 20 wt % to about 70 wt %, or about 5 wt % or less, or about 10, 15, 20, 25, 30, 35, 40, 45, 50, 55, 60, 65, 70, 75, 80, 85, 90, or about 95 wt % or more. Examples of the carrier fluid can include diethylene glycol monomethyl or dimethyl ether, methanol, dipropylene glycol monomethyl ether, dipropylene glycol dimethyl ether, dimethyl formamide, ethylene glycol butyl ether, diethylene glycol butyl ether, propylene carbonate, d-limonene, fatty acid methyl esters, propylene glycol butyl ether, ethylene glycol monoacetate, triethylene glycol monoethyl ether, 1,1′-oxybis(2-propanol), triethylene glycol monomethyl ether, triglyme, diglyme, butyl lactate, butylglycidyl ether, propylene carbonate, butyl alcohol, d-limonene, glycol ether solvents, 2-butoxy ethanol, ethers of a C₂ to C₆ dihydric alkanol containing at least one C₁ to C₆ alkyl group, mono ethers of dihydric alkanols, methoxypropanol, butoxyethanol, hexoxyethanol, isomers thereof, and combinations thereof. The carrier fluid can have a high flash point (e.g., over 125° F.).

Any solvent that is compatible with the curable resin and achieves the desired viscosity effect is suitable for use in the curable resin. Some examples of solvents are those having high flash points (e.g., about 125° F.) such as butyl lactate, butylglycidyl ether, propylene carbonate, butyl alcohol, d-limonene, glycol ether solvents, 2-butoxy ethanol, ethers of a C₂ to C₆ dihydric alkanol containing at least one C₁ to C₆ alkyl group, mono ethers of dihydric alkanols, methoxypropanol, butoxyethanol, hexoxyethanol, and isomers thereof.

In some embodiments, the composition further includes a silane coupling agent. The silane coupling agent can be any suitable silane coupling agent. For example, the silane coupling agent can be a hydrocarbyl-substituted trimethoxysilane, wherein the hydrocarbyl group is substituted or unsubstituted. The silane coupling agent can be N-2-(aminoethyl)-3-aminopropyltrimethoxysilane, 3-glycidoxypropyltrimethoxysilane, or n-beta-(aminoethyl)-gamma-aminopropyltrimethoxysilane. Any suitable amount of the composition can be the silane coupling agent, such as about 0.001 wt % to about 20 wt %, or about 0.001 wt % to about 3 wt %, or about 0.001 wt % or less, or about 0.01, 0.1, 1, 2, 3, 4, 5, 6, 8, 10, 12, 14, 16, 18, or about 20 wt % or more.

In some embodiments, the composition further includes a surfactant. In some embodiments, the surfactant can facilitate the coating of the POSS on particles and the flowing of the POSS to contact points between adjacent particles. The surfactant can be any suitable surfactant, such as a cationic surfactant, an anionic surfactant, or a non-ionic surfactant. In some embodiments, the surfactant can be at least one of an ethoxylated nonyl phenol phosphate ester, a mixture of one or more cationic surfactants, a C₁₂-C₂₂ alkyl phosphonate, or a mixture of one or more non-ionic surfactants and an alkyl phosphonate surfactant. The surfactant can form any suitable amount of the composition, such as about 0.01 wt % to about 50 wt %, or about 0.1 wt % to about 10 wt %, or about 0.01 wt % or less, or about 0.1, 1, 2, 3, 4, 5, 10, 15, 20, 25, 30, 35, 40, 45, or about 50 wt % or more.

In one example, the surfactant is sorbitan monooletate. In one example, the surfactant can be a non-ionic surfactant. Examples of non-ionic surfactants can include polyoxyethylene alkyl ethers, polyoxyethylene alkylphenol ethers, polyoxyethylene lauryl ethers, polyoxyethylene sorbitan monoleates, polyoxyethylene alkyl esters, polyoxyethylene sorbitan alkyl esters, polyethylene glycol, polypropylene glycol, diethylene glycol, ethoxylated trimethylnonanols, polyoxyalkylene glycol modified polysiloxane surfactants, and mixtures, copolymers or reaction products thereof. In one example, the surfactant is polyglycol-modified trimethylsilylated silicate surfactant.

Examples of suitable cationic surfactants can include, but are not limited to, quaternary ammonium hydroxides such as octyl trimethyl ammonium hydroxide, dodecyl trimethyl ammonium hydroxide, hexadecyl trimethyl ammonium hydroxide, octyl dimethyl benzyl ammonium hydroxide, decyl dimethyl benzyl ammonium hydroxide, didodecyl dimethyl ammonium hydroxide, dioctadecyl dimethyl ammonium hydroxide, tallow trimethyl ammonium hydroxide and coco trimethyl ammonium hydroxide as well as corresponding salts of these materials, fatty amines and fatty acid amides and their derivatives, basic pyridinium compounds, and quaternary ammonium bases of benzimidazolines and poly(ethoxylated/propoxylated) amines.

Examples of suitable anionic surfactants can include, but are not limited to, alkyl sulphates such as lauryl sulphate, polymers such as acrylates/C₁₀₋₃₀ alkyl acrylate crosspolymer alkylbenzenesulfonic acids and salts such as hexylbenzenesulfonic acid, octylbenzenesulfonic acid, decylbenzenesulfonic acid, dodecylbenzenesulfonic acid, cetylbenzenesulfonic acid and myristylbenzenesulfonic acid; the sulphate esters of monoalkyl polyoxyethylene ethers; alkylnapthylsulfonic acid; alkali metal sulfoccinates, sulfonated glyceryl esters of fatty acids such as sulfonated monoglycerides of coconut oil acids, salts of sulfonated monovalent alcohol esters, amides of amino sulfonic acids, sulfonated products of fatty acid nitriles, sulfonated aromatic hydrocarbons, condensation products of naphthalene sulfonic acids with formaldehyde, sodium octahydroanthracene sulfonate, alkali metal alkyl sulphates, ester sulphates, and alkarylsulfonates. Anionic surfactants can include alkali metal soaps of higher fatty acids, alkylaryl sulfonates such as sodium dodecyl benzene sulfonate, long chain fatty alcohol sulfates, olefin sulfates and olefin sulfonates, sulfated monoglycerides, sulfated esters, sulfonated ethoxylated alcohols, sulfosuccinates, alkane sulfonates, phosphate esters, alkyl isethionates, alkyl taurates, and alkyl sarcosinates.

Examples of suitable non-ionic surfactants can include, but are not limited to, condensates of ethylene oxide with long chain fatty alcohols or fatty acids such as a (C₁₂₋₁₆)alcohol, condensates of ethylene oxide with an amine or an amide, condensation products of ethylene and propylene oxide, esters of glycerol, sucrose, sorbitol, fatty acid alkylol amides, sucrose esters, fluoro-surfactants, fatty amine oxides, polyoxyalkylene alkyl ethers such as polyethylene glycol long chain alkyl ether, polyoxyalkylene sorbitan ethers, polyoxyalkylene alkoxylate esters, polyoxyalkylene alkylphenol ethers, ethylene glycol propylene glycol copolymers and alkylpolysaccharides, polymeric surfactants such as polyvinyl alcohol (PVA) and polyvinylmethylether. In certain embodiments, the surfactant is a polyoxyethylene fatty alcohol or mixture of polyoxyethylene fatty alcohols. In other embodiments, the surfactant is an aqueous dispersion of a polyoxyethylene fatty alcohol or mixture of polyoxyethylene fatty alcohols.

In some embodiments, the surfactant can be selected from Tergitol™ 15-s-3, Tergitol™ 15-s-40, sorbitan monooleate, polylycol-modified trimethsilylated silicate, polyglycol-modified siloxanes, polyglycol-modified silicas, ethoxylated quaternary ammonium salt solutions, and cetyltrimethylammonium chloride solutions.

In some embodiments, the composition can further include a hydrolyzable ester. The hydrolyzable ester can be any suitable hydrolyzable ester. For example, the hydrolyzable ester can be a C₁-C₅ mono-, di-, tri-, or tetra-alkyl ester of a C₂-C₄₀ mono-, di-, tri-, or tetra-carboxylic acid. The hydrolyzable ester can be at least one of dimethylglutarate, dimethyladipate, dimethylsuccinate, sorbitol, catechol, dimethylthiolate, methyl salicylate, dimethylsalicylate, tert-butylhydroperoxide, and butyl lactate. Any suitable wt % of the composition can be the hydrolyzable ester, such as about 0.01 wt % to about 20 wt %, or about 0.1 wt % to about 5 wt %, or about 0.01 wt % or less, or about 0.1 wt %, 1, 2, 3, 4, 5, 6, 8, 10, 12, 14, 16, 18, or about 20 wt % or more.

In some embodiments, the composition includes at least one of a gel or a crosslinked gel. For example, the gel or crosslinked gel can include at least one of a linear polysaccharide and a poly((C₂-C₁₀)alkenylene), wherein the (C₂-C₁₀)alkenylene is substituted or unsubstituted. In some examples, the gel or crosslinked gel can include at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), acetan, alginate, chitosan, curdlan, a cyclosophoran, dextran, emulsan, a galactoglucopolysaccharide, gellan, glucuronan, N-acetyl-glucosamine, N-acetyl-heparosan, hyaluronic acid, indicant, kefiran, lentinan, levan, mauran, pullulan, scleroglucan, schizophyllan, stewartan, succinoglycan, xanthan, welan, starch, tamarind, tragacanth, guar gum, derivatized guar, gum ghatti, gum arabic, locust bean gum, cellulose, carboxymethyl cellulose, hydroxyethyl cellulose, carboxymethyl hydroxyethyl cellulose, hydroxypropyl cellulose, methyl hydroxyl ethyl cellulose, guar, hydroxypropyl guar, carboxy methyl guar, and carboxymethyl hydroxylpropyl guar. The gel or crosslinked gel can form any suitable proportion of the composition, such as about 0.001 wt % to about 10 wt % of the composition, about 0.001 wt % or less, or about 0.005 wt %, 0.01, 0.05, 0.1, 0.2, 0.3, 0.4, 0.5, 0.6, 0.7, 0.8, 0.9, 1, 1.5, 2, 3, 4, 5, 6, 7, 8, 9, or about 10 wt % of the composition.

In some examples, the composition further includes at least one crosslinking agent. The crosslinking agent can be any suitable crosslinking agent. For example, the crosslinking agent can include at least one of chromium, aluminum, antimony, zirconium, titanium, calcium, boron, iron, silicon, copper, zinc, magnesium, and an ion thereof. The crosslinking agent can include at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, and zirconium lactate glycolate, titanium lactate, titanium malate, titanium citrate, titanium ammonium lactate, titanium triethanolamine, titanium acetylacetonate, aluminum lactate, and aluminum citrate. The crosslinker can be present in any suitable proportion of the composition, such as about 0.000.001 wt % to about 5 wt % of the composition, about 0.001 wt % to about 2 wt % of the composition, or about 0.000.001 wt % or less, or about 0.000.01 wt %, 0.000, 1, 0.001, 0.01, 0.1, 1, 1.5, 2, 2.5, 3, 3.5, 4, 4.5, or about 5 wt % of the composition or more.

### Downhole Mixture or Composition.

The curable composition can be combined with any suitable downhole fluid before, during, or after the placement of the composition in the subterranean formation or the contacting of the composition and the subterranean material. In some examples, the curable composition is combined with a downhole fluid above the surface, and then the combined composition is placed in a subterranean formation or contacted with a subterranean material. In another example, the curable composition is injected into a subterranean formation to combine with a downhole fluid, and the combined composition is contacted with a subterranean material or is considered to be placed in the subterranean formation. In various examples, at least one of prior to, during, and after the placement of the composition in the subterranean formation or contacting of the subterranean material and the composition, the composition is used downhole, at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof.

In various embodiments, the method includes combining the curable composition with any suitable downhole fluid, such as an aqueous or oil-based fluid including a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof, to form a mixture. The placement of the composition in the subterranean formation can include contacting the subterranean material and the mixture. The contacting of the subterranean material and the composition can include contacting the subterranean material and the mixture. Any suitable weight percent of a mixture that is placed in the subterranean formation or contacted with the subterranean material can be the curable composition, such as about 0.000.000.01 wt % to 99.999.99 wt %, 0.000.1 wt %-99.9 wt %, 0.1 wt % to 99.9 wt %, or about 20 wt %-90 wt %, or about 0.000.000.01 wt % or less, or about 0.000.001 wt %, 0.000.1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99, 99.999, 99.999.9 wt %, or about 99.999.99 wt % or more of the mixture or composition.

In some embodiments, the composition can include any suitable amount of any suitable material used in a downhole fluid. For example, the composition can include water, saline, aqueous base, acid, oil, organic solvent, synthetic fluid oil phase, aqueous solution, alcohol or polyol, cellulose, starch, alkalinity control agents, acidity control agents, density control agents, density modifiers, emulsifiers, dispersants, polymeric stabilizers, crosslinking agents, polyacrylamide, a polymer or combination of polymers, antioxidants, heat stabilizers, foam control agents, solvents, diluents, plasticizer, filler or inorganic particle, pigment, dye, precipitating agent, rheology modifier, oil-wetting agents, set retarding additives, surfactants, gases, weight reducing additives, heavy-weight additives, lost circulation materials, filtration control additives, salts, fibers, thixotropic additives, breakers, crosslinkers, rheology modifiers, curing accelerators, curing retarders, pH modifiers, chelating agents, scale inhibitors, enzymes, resins, water control materials, oxidizers, markers, Portland cement, pozzolana cement, gypsum cement, high alumina content cement, slag cement, silica cement, fly ash, metakaolin, shale, zeolite, a crystalline silica compound, amorphous silica, hydratable clays, microspheres, pozzolan lime, or a combination thereof. In various embodiments, the composition can include one or more additive components such as: thinner additives such as COLDTROL®, ATC®, OMC 2™, and OMC 42™; RHEMOD™, a viscosifier and suspension agent including a modified fatty acid; additives for providing temporary increased viscosity, such as for shipping (e.g., transport to the well site) and for use in sweeps (for example, additives having the trade name TEMPERUS™ (a modified fatty acid) and VIS-PLUS®, a thixotropic viscosifying polymer blend); TAU-MOD™, a viscosifying/suspension agent including an amorphous/fibrous material; additives for filtration control, for example, ADAPTA®, a HTHP filtration control agent including a crosslinked copolymer; DURATONE® HT, a filtration control agent that includes an organophilic lignite, more particularly organophilic leonardite; THERMO TONE™, a high temperature high pressure (HTHP) filtration control agent including a synthetic polymer; BDF™-366, a HTHP filtration control agent; BDF™-454, a HTHP filtration control agent; LIQUITONE™, a polymeric filtration agent and viscosifier; additives for HTHP emulsion stability, for example, FACTANT™, which includes highly concentrated tall oil derivative; emulsifiers such as LE SUPERMUL™ and EZ MUL® NT, polyaminated fatty acid emulsifiers, and FORTI-MUL®; DRIL TREAT®, an oil wetting agent for heavy fluids; BARACARB®, a sized ground marble bridging agent; BAROID®, a ground barium sulfate weighting agent; BAROLIFT®, a hole sweeping agent; SWEEP-WATE®, a sweep weighting agent; BDF-508, a diamine dimer rheology modifier; GELTONE® II organophilic clay; BAROFIBRE™ O for lost circulation management and seepage loss prevention, including a natural cellulose fiber; STEELSEAL®, a resilient graphitic carbon lost circulation material; HYDRO-PLUG®, a hydratable swelling lost circulation material; lime, which can provide alkalinity and can activate certain emulsifiers; and calcium chloride, which can provide salinity. Any suitable proportion of the composition can include any optional component listed in this paragraph, such as about 0.000.000.01 wt % to 99.999.99 wt %, 0.000.1-99.9 wt %, 0.1 wt % to 99.9 wt %, or about 20-90 wt %, or about 0.000.000.01 wt % or less, or about 0.000.001 wt %, 0.000.1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99, 99.999, 99.999.9, or about 99.999.99 wt % or more of the composition.

A drilling fluid, also known as a drilling mud or simply “mud,” is a specially designed fluid that is circulated through a wellbore as the wellbore is being drilled to facilitate the drilling operation. The drilling fluid can be water-based or oil-based. The drilling fluid can carry cuttings up from beneath and around the bit, transport them up the annulus, and allow their separation. Also, a drilling fluid can cool and lubricate the drill head as well as reduce friction between the drill string and the sides of the hole. The drilling fluid aids in support of the drill pipe and drill head, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks and also to form a thin, low permeability filter cake that temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase. A drilling fluid can be present in the mixture with the curable composition in any suitable amount, such as about 1 wt % or less, about 2 wt %, 3, 4, 5, 10, 15, 20, 30, 40, 50, 60, 70, 80, 85, 90, 95, 96, 97, 98, 99, 99.9, 99.99, 99.999, or about 99.9999 wt % or more of the mixture.

A water-based drilling fluid in embodiments of the present invention can be any suitable water-based drilling fluid. In various embodiments, the drilling fluid can include at least one of water (fresh or brine), a salt (e.g., calcium chloride, sodium chloride, potassium chloride, magnesium chloride, calcium bromide, sodium bromide, potassium bromide, calcium nitrate, sodium formate, potassium formate, cesium formate), aqueous base (e.g., sodium hydroxide or potassium hydroxide), alcohol or polyol, cellulose, starches, alkalinity control agents, density control agents such as a density modifier (e.g., barium sulfate), surfactants (e.g., betaines, alkali metal alkylene acetates, sultaines, ether carboxylates), emulsifiers, dispersants, polymeric stabilizers, crosslinking agents, polyacrylamides, polymers or combinations of polymers, antioxidants, heat stabilizers, foam control agents, solvents, diluents, plasticizers, filler or inorganic particles (e.g., silica), pigments, dyes, precipitating agents (e.g., silicates or aluminum complexes), and rheology modifiers such as thickeners or viscosifiers (e.g., xanthan gum). Any ingredient listed in this paragraph can be either present or not present in the mixture.

An oil-based drilling fluid or mud in embodiments of the present invention can be any suitable oil-based drilling fluid. In various embodiments the drilling fluid can include at least one of an oil-based fluid (or synthetic fluid), saline, aqueous solution, emulsifiers, other agents of additives for suspension control, weight or density control, oil-wetting agents, fluid loss or filtration control agents, and rheology control agents. For example, see H. C. H. Darley and George R. Gray, Composition and Properties of Drilling and Completion Fluids 66-67, 561-562 (5^{th} ed. 1988). An oil-based or invert emulsion-based drilling fluid can include between about 10:90 to about 95:5, or about 50:50 to about 95:5, by volume of oil phase to water phase. A substantially all oil mud includes about 100% liquid phase oil by volume (e.g., substantially no internal aqueous phase).

A pill is a relatively small quantity (e.g., less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

A cement fluid can include an aqueous mixture of at least one of cement and cement kiln dust. The cement kiln dust can be any suitable cement kiln dust. Cement kiln dust can be formed during the manufacture of cement and can be partially calcined kiln feed that is removed from the gas stream and collected in a dust collector during a manufacturing process. Cement kiln dust can be advantageously utilized in a cost-effective manner since kiln dust is often regarded as a low value waste product of the cement industry. Some embodiments of the cement fluid can include cement kiln dust but no cement, cement kiln dust and cement, or cement but no cement kiln dust. The cement can be any suitable cement. The cement can be a hydraulic cement. A variety of cements can be utilized in accordance with embodiments of the present invention; for example, those including calcium, aluminum, silicon, oxygen, iron, or sulfur, which can set and harden by reaction with water. Suitable cements can include Portland cements, pozzolana cements, gypsum cements, high alumina content cements, slag cements, silica cements, and combinations thereof. In some embodiments, the Portland cements that are suitable for use in embodiments of the present invention are classified as Classes A, C, H, and G cements according to the American Petroleum Institute, API Specification for Materials and Testing for Well Cements, API Specification 10, Fifth Ed., Jul. 1, 1990. A cement can be generally included in the cementing fluid in an amount sufficient to provide the desired compressive strength, density, or cost. In some embodiments, the hydraulic cement can be present in the cementing fluid in an amount in the range of from 0 wt % to about 100 wt %, 0-95 wt %, 20-95 wt %, or about 50-90 wt %. A cement kiln dust can be present in an amount of at least about 0.01 wt %, or about 5 wt %-80 wt %, or about 10 wt % to about 50 wt %.

Optionally, other additives can be added to a cement or kiln dust-containing composition of embodiments of the present invention as deemed appropriate by one skilled in the art, with the benefit of this disclosure. Any optional ingredient listed in this paragraph can be either present or not present in the composition. For example, the composition can include fly ash, metakaolin, shale, zeolite, set retarding additive, surfactant, a gas, accelerators, weight reducing additives, heavy-weight additives, lost circulation materials, filtration control additives, dispersants, and combinations thereof. In some examples, additives can include crystalline silica compounds, amorphous silica, salts, fibers, hydratable clays, microspheres, pozzolan lime, thixotropic additives, combinations thereof, and the like.

In various embodiments, the composition or mixture can include a proppant, a resin-coated proppant, an encapsulated resin, or a combination thereof. A proppant is a material that keeps an induced hydraulic fracture at least partially open during or after a fracturing treatment. Proppants can be transported downhole to the fracture using fluid, such as fracturing fluid or another fluid. A higher-viscosity fluid can more effectively transport proppants to a desired location in a fracture, especially larger proppants, by more effectively keeping proppants in a suspended state within the fluid. Examples of proppants can include sand, gravel, glass beads, polymer beads, ground products from shells and seeds such as walnut hulls, and manmade materials such as ceramic proppant, bauxite, tetrafluoroethylene materials (e.g., TEFLON™ available from DuPont), fruit pit materials, processed wood, composite particulates prepared from a binder and fine grade particulates such as silica, alumina, fumed silica, carbon black, graphite, mica, titanium dioxide, meta-silicate, calcium silicate, kaolin, talc, zirconia, boron, fly ash, hollow glass microspheres, and solid glass, or mixtures thereof. In some embodiments, proppant can have an average particle size, wherein particle size is the largest dimension of a particle, of about 0.001 mm to about 3 mm, about 0.15 mm to about 2.5 mm, about 0.25 mm to about 0.43 mm, about 0.43 mm to about 0.85 mm, about 0.85 mm to about 1.18 mm, about 1.18 mm to about 1.70 mm, or about 1.70 to about 2.36 mm. In some embodiments, the proppant can have a distribution of particle sizes clustering around multiple averages, such as one, two, three, or four different average particle sizes. The composition or mixture can include any suitable amount of proppant, such as about 0.000.1 wt %-99.9 wt %, 0.1 wt % to 80 wt %, or about 10 wt %-60 wt %, or about 0.000.000.01 wt % or less, or about 0.000.001 wt %, 0.000.1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, 99.9 wt %, or about 99.99 wt % or more.

The composition can include a payload material. The payload can be deposited in any suitable downhole location. The method can include using the composition to deposit a payload material into a subterranean fracture. The subterranean fracture can be any suitable subterranean fracture. In some embodiments, the method includes forming the subterranean fracture; in other embodiments, the subterranean fracture is already formed. The payload material can be a proppant, or any other suitable payload material, such as a resin-coated proppant, a curable material, an encapsulated resin, a resin, a Portland cement, a pozzolana cement, a gypsum cement, a high alumina content cement, a slag cement, a silica cement, a cementitous kiln dust, fly ash, metakaolin, shale, zeolite, a set retarding additive, a corrosion inhibitor, a surfactant, a gas, an accelerator, a weight reducing additive, a heavy-weight additive, a lost circulation material, a filtration control additive, a dispersant, a crystalline silica compound, an amorphous silica, a salt, a fiber, a hydratable clay, a microsphere, pozzolan lime, a thixotropic additive, water, an aqueous base, an aqueous acid, an alcohol or polyol, a cellulose, a starch, an alkalinity control agent, an acidity control agent, a density control agent, a density modifier, an emulsifier, a polymeric stabilizer, a crosslinking agent, a polyacrylamide, a polymer or combination of polymers, an antioxidant, a heat stabilizer, a foam control agent, a solvent, a diluent, a plasticizer, a filler or inorganic particle, a pigment, a dye, a precipitating agent, a rheology modifier, or a combination thereof.

### Drilling Assembly.

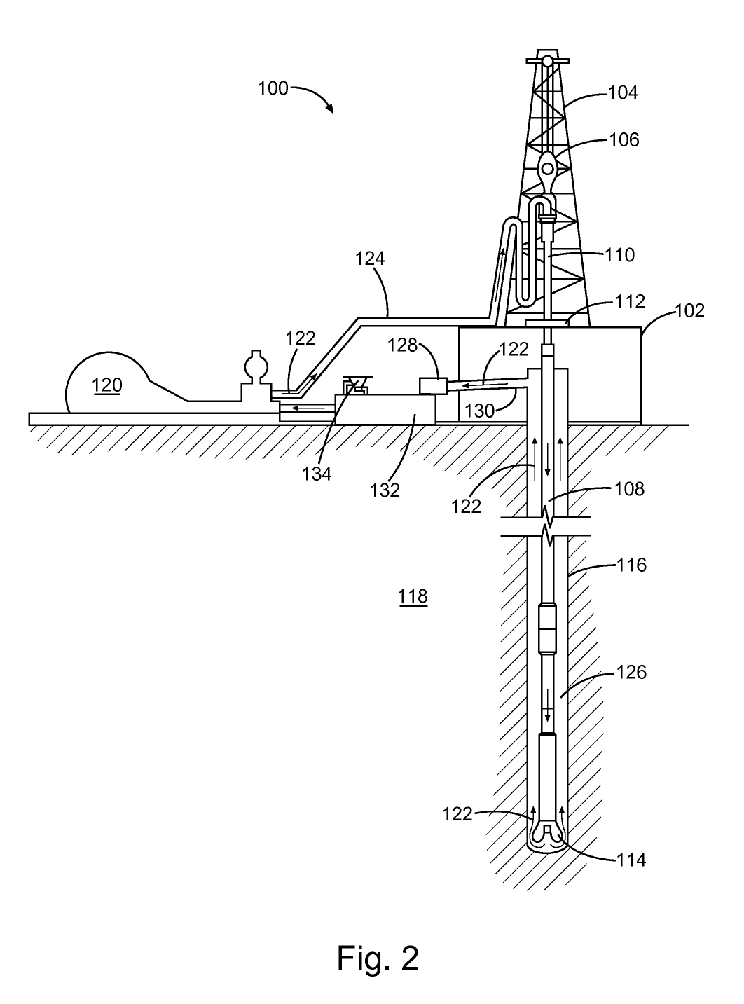

The curable composition including the POSS and the curably reactive agent or a cured product thereof may directly or indirectly affect one or more components or pieces of equipment associated with the preparation, delivery, recapture, recycling, reuse, and/or disposal of the curable composition. For example, and with reference to FIG. 2, the curable composition or a cured product thereof may directly or indirectly affect one or more components or pieces of equipment associated with an exemplary wellbore drilling assembly 100, according to one or more embodiments. It should be noted that while FIG. 2 generally depicts a land-based drilling assembly, those skilled in the art will readily recognize that the principles described herein are equally applicable to subsea drilling operations that employ floating or sea-based platforms and rigs, without departing from the scope of the disclosure.

In some embodiments the method of treating a subterranean formation includes contacting the composition with a drilling apparatus. In some embodiments the placing of the composition in the subterranean formation downhole includes pumping the composition through a drill string disposed in a wellbore, and through a drill bit at a downhole end of the drill string. The method can include pumping the composition back above-surface through an annulus. The method can further include processing the composition exiting the annulus with at least one fluid processing unit to generate a cleaned composition and recirculating the cleaned composition through the wellbore. In various embodiments, the present invention can provide a system including a drilling apparatus and a subterranean formation comprising the curable composition or a cured product thereof therein. The system can include a drillstring disposed in a wellbore, the drillstring including a drill bit at the downhole end of the drillstring. The system can include an annulus between the drillstring and the wellbore. The system can include a pump configured to circulate the composition through the drill string and through the drill bit. In some embodiments, the pump can circulate the composition back above-surface through the annulus. The system can further include a fluid processing unit configured to process the composition exiting the annulus to generate a cleaned drilling fluid for recirculation through the wellbore.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the wellbore 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (e.g., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the disclosure.

The curable composition may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the curable composition may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the curable composition may be stored, reconditioned, and/or regulated until added to the drilling fluid 122.

As mentioned above, the curable composition may directly or indirectly affect the components and equipment of the drilling assembly 100. For example, the curable composition may directly or indirectly affect the fluid processing unit(s) 128, which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 may further include one or more sensors, gauges, pumps, compressors, and the like used to store, monitor, regulate, and/or recondition the curable composition.

The curable composition or cured product thereof may directly or indirectly affect the pump 120, which representatively includes any conduits, pipelines, trucks, tubulars, and/or pipes used to fluidically convey the curable composition downhole, any pumps, compressors, or motors (e.g., topside or downhole) used to drive the composition into motion, any valves or related joints used to regulate the pressure or flow rate of the composition, and any sensors (e.g., pressure, temperature, flow rate, and the like), gauges, and/or combinations thereof, and the like. The curable composition or a cured product thereof can directly or indirectly affect the mixing hopper 134 and the retention pit 132 and their assorted variations.

The curable composition or a cured product thereof may also directly or indirectly affect the various downhole equipment and tools that may come into contact with the composition or the cured product such as, but not limited to, the drill string 108, any floats, drill collars, mud motors, downhole motors, and/or pumps associated with the drill string 108, and any measurement while drilling (MWD)/logging while drilling (LWD) tools and related telemetry equipment, sensors, or distributed sensors associated with the drill string 108. The curable composition or cured product thereof may also directly or indirectly affect any downhole heat exchangers, valves and corresponding actuation devices, tool seals, packers and other wellbore isolation devices or components, and the like associated with the wellbore 116. The curable composition or cured product thereof may also directly or indirectly affect the drill bit 114, which may include, but is not limited to, roller cone bits, polycrystalline diamond compact (PDC) bits, natural diamond bits, any hole openers, reamers, coring bits, and the like.

While not specifically illustrated herein, the curable composition or a cured product thereof may also directly or indirectly affect any transport or delivery equipment used to convey the curable composition to the drilling assembly 100 such as, for example, any transport vessels, conduits, pipelines, trucks, tubulars, and/or pipes used to fluidically move the curable composition from one location to another, any pumps, compressors, or motors used to drive the composition into motion, any valves or related joints used to regulate the pressure or flow rate of the composition, and any sensors (e.g., pressure and temperature), gauges, and/or combinations thereof, and the like.

### System or Apparatus.

In various embodiments, the present invention provides a system. The system can be any suitable system that can include the use of the curable composition described herein of the cured product thereof in a subterranean formation, or that can include performance of a method for using the curable composition described herein. The system can include a composition including a polyhedral oligomeric silsesquioxane (POSS) comprising at least one curable or curing group. The composition can include an agent curably reactive with the curable or curing groups. The system can also include a subterranean formation including the composition therein, or a cured product thereof. In some embodiments, the composition in the system can also include gravel or proppant.

In various embodiments, the present invention provides a system for performing an embodiment of the method including a tubular disposed in a wellbore. The system can also include a pump configured to pump the curable composition downhole. In various embodiments, the present invention provides a system formed by an embodiment of the method, including a subterranean formation comprising at least one of the cured composition or a cured product of the curable composition.

In various embodiments, the present invention provides an apparatus. The apparatus can be any suitable apparatus that can use the curable composition described herein or the cured product thereof in a subterranean formation, or that can be used to perform a method for using the curable composition described herein or a cured product thereof.

Various embodiments provide systems and apparatus configured for delivering the composition described herein to a downhole location and for using the composition therein, such as for primary proppant treatments for immobilizing proppant particulates (e.g., hydraulic fracturing, gravel packing, and frac-packing), remedial proppant/gravel treatments, near-wellbore formation sand consolidation treatments for sand control, consolidating-while-drilling target intervals, and plugging-and-abandonment of wellbores in subterranean formations. In various embodiments, the systems can include a pump fluidly coupled to a tubular (e.g., any suitable type of oilfield pipe, such as pipeline, drill pipe, production tubing, and the like), the tubular containing an embodiment of the curable composition described herein.

The pump can be a high pressure pump in some embodiments. As used herein, the term “high pressure pump” will refer to a pump that is capable of delivering a fluid downhole at a pressure of about 1000 psi or greater. A high pressure pump can be used when it is desired to introduce the composition to a subterranean formation at or above a fracture gradient of the subterranean formation, but it can also be used in cases where fracturing is not desired. In some embodiments, the high pressure pump can be capable of fluidly conveying particulate matter, such as proppant particulates, into the subterranean formation. Suitable high pressure pumps will be known to one having ordinary skill in the art and can include, but are not limited to, floating piston pumps and positive displacement pumps.

In other embodiments, the pump can be a low pressure pump. As used herein, the term “low pressure pump” will refer to a pump that operates at a pressure of about 1000 psi or less. In some embodiments, a low pressure pump can be fluidly coupled to a high pressure pump that is fluidly coupled to the tubular. That is, in such embodiments, the low pressure pump can be configured to convey the composition to the high pressure pump. In such embodiments, the low pressure pump can “step up” the pressure of the composition before it reaches the high pressure pump.

In some embodiments, the systems or apparatuses described herein can further include a mixing tank that is upstream of the pump and in which the composition is formulated. In various embodiments, the pump (e.g., a low pressure pump, a high pressure pump, or a combination thereof) can convey the composition from the mixing tank or other source of the composition to the tubular. In other embodiments, however, the composition can be formulated offsite and transported to a worksite, in which case the composition can be introduced to the tubular via the pump directly from its shipping container (e.g., a truck, a railcar, a barge, or the like) or from a transport pipeline. In either case, the composition can be drawn into the pump, elevated to an appropriate pressure, and then introduced into the tubular for delivery downhole.

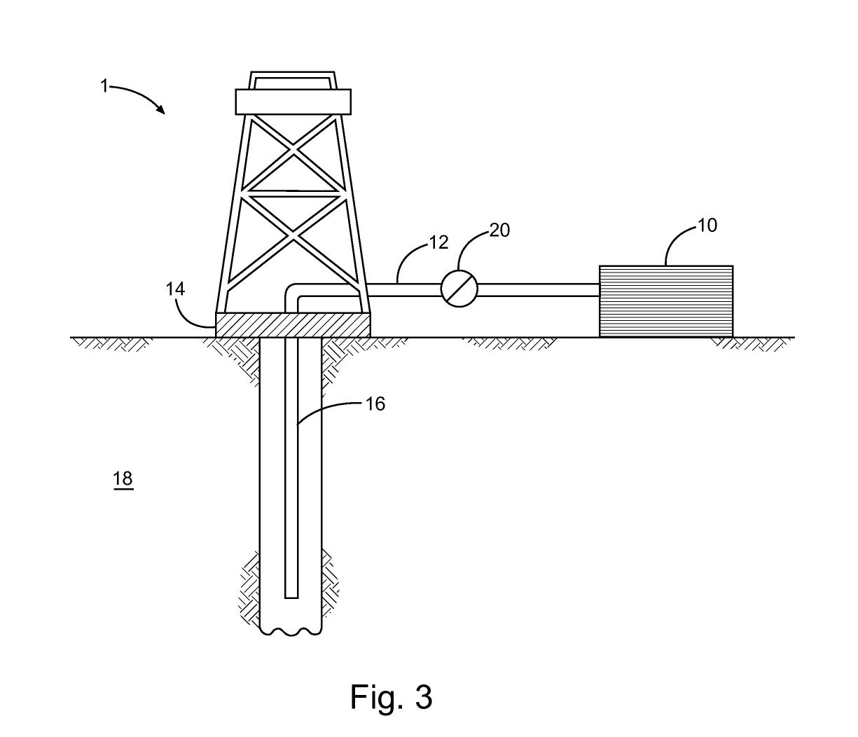

FIG. 3 shows an illustrative schematic of systems and apparatuses that can deliver embodiments of the compositions of the present invention to a downhole location, according to one or more embodiments. It should be noted that while FIG. 3 generally depicts a land-based system or apparatus, it is to be recognized that like systems and apparatuses can be operated in subsea locations as well. Embodiments of the present invention can have a different scale than that depicted in FIG. 3. As depicted in FIG. 3, system or apparatus 1 can include mixing tank 10, in which an embodiment of the composition can be formulated. The composition can be conveyed via line 12 to wellhead 14, where the composition enters tubular 16, with tubular 16 extending from wellhead 14 into subterranean formation 18. Upon being ejected from tubular 16, the composition can subsequently penetrate into subterranean formation 18. Pump 20 can be configured to raise the pressure of the composition to a desired degree before its introduction into tubular 16. It is to be recognized that system or apparatus 1 is merely exemplary in nature and various additional components can be present that have not necessarily been depicted in FIG. 3 in the interest of clarity. Non-limiting additional components that can be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 3, at least part of the composition can, in some embodiments, flow back to wellhead 14 and exit subterranean formation 18. The composition that flows back can be substantially diminished in the concentration of the POSS, the curably reactive agent, a proppant or gravel, or other components. In some embodiments, the composition that has flowed back to wellhead 14 can subsequently be recovered, and in some examples reformulated, and recirculated to subterranean formation 18.

It is also to be recognized that the disclosed composition can also directly or indirectly affect the various downhole equipment and tools that can come into contact with the composition during operation. Such equipment and tools can include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described above and depicted in FIG. 3.

### Composition for Treatment of a Subterranean Formation.

Various embodiments provide a composition for treatment of a subterranean formation. The composition can be any suitable composition that can be used to perform an embodiment of the method for treatment of a subterranean formation described herein.

For example, the composition can include a polyhedral oligomeric silsesquioxane (POSS) comprising at least one curable or curing group. The composition can also include an agent curably reactive with the curable or curing groups. In some embodiments, the composition further includes gravel or a proppant. In some embodiments, the composition further includes a downhole fluid. The downhole fluid can be any suitable downhole fluid. In some embodiments, the downhole fluid is a composition for fracturing of a subterranean formation or subterranean material, or a fracturing fluid.

Various embodiments provide a cured product of an embodiment of the curable composition described herein.

### Method for Preparing a Composition for Treatment of a Subterranean Formation.

In various embodiments, the present invention provides a method for preparing a composition for treatment of a subterranean formation. The method can be any suitable method that produces a composition described herein. For example, the method can include forming a composition including a polyhedral oligomeric silsesquioxane (POSS) comprising at least one curable or curing group. The composition can also include an agent curably reactive with the curable or curing groups.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of treating a subterranean formation, the method comprising:
obtaining or providing a curable composition comprising
   a polyhedral oligomeric silsesquioxane (POSS) comprising at least one curable or curing group; and
   an agent curably reactive with the curable or curing groups; and placing the composition in a subterranean formation downhole.

Embodiment 2 provides the method of Embodiment 1, wherein the obtaining or providing of the composition occurs above-surface.

Embodiment 3 provides the method of any one of Embodiments 1-2, wherein the obtaining or providing of the composition occurs downhole.

Embodiment 4 provides the method of any one of Embodiments 1-3, further comprising placing proppant in the subterranean formation prior to placing the composition in the subterranean formation.

Embodiment 5 provides the method of any one of Embodiments 1-4, further comprising placing proppant in the subterranean formation after placing the composition in the subterranean formation.

Embodiment 6 provides the method of any one of Embodiments 1-5, wherein the composition further comprises at least one of proppant and gravel.

Embodiment 7 provides the method of Embodiment 6, wherein the proppant or gravel is about 1 wt % to about 90 wt % of the composition.

Embodiment 8 provides the method of any one of Embodiments 6-7, wherein the proppant or gravel is about 5 wt % to about 70 wt % of the composition.

Embodiment 9 provides the method of any one of Embodiments 6-8, wherein the method further comprises coating a mixture comprising the POSS and the curably reactive agent on the proppant or gravel.

Embodiment 10 provides the method of any one of Embodiments 1-9, comprising placing the composition in at least one of a fracture and flowpath in the subterranean formation.

Embodiment 11 provides the method of Embodiment 10, wherein the fracture is present in the subterranean formation when the composition is placed in the subterranean formation.

Embodiment 12 provides the method of any one of Embodiments 10-11, wherein the method comprises forming the fracture or flowpath.

Embodiment 13 provides the method of any one of Embodiments 1-12, further comprising fracturing the subterranean formation to form at least one fracture in the subterranean formation.

Embodiment 14 provides the method of any one of Embodiments 1-13, wherein the POSS is in a liquid form or is substantially dissolved in the composition.

Embodiment 15 provides the method of any one of Embodiments 1-14, wherein the POSS is in a substantially solid form.

Embodiment 16 provides the method of Embodiment 15, wherein the composition further comprises proppant having coated thereon the agent curably reactive with the curable or curing groups.

Embodiment 17 provides the method of Embodiment 16, wherein conditions downhole melt the solid POSS and activate a curing process.

Embodiment 18 provides the method of any one of Embodiments 1-17, wherein obtaining or providing the composition comprises obtaining or providing part I, wherein part I comprises the POSS; obtaining or providing part II, wherein part II comprises the curing agent; and mixing part I and part II.

Embodiment 19 provides the method of any one of Embodiments 1-18, wherein the method is a method of remedial proppant or gravel treatment.

Embodiment 20 provides the method of any one of Embodiments 1-19, wherein the method is a method of near-wellbore treatment during a drilling operation.

Embodiment 21 provides the method of any one of Embodiments 1-20 wherein the method is a method of near-wellbore formation sand consolidation treatments for sand control.

Embodiment 22 provides the method of any one of Embodiments 1-21, wherein the method is a method of consolidating-while-drilling target intervals.

Embodiment 23 provides the method of any one of Embodiments 1-22, wherein the method is a method of plugging-and-abandonment of wellbores in subterranean formations.

Embodiment 24 provides the method of any one of Embodiments 1-23, further comprising allowing the composition to at least partially cure.

Embodiment 25 provides the method of Embodiment 24, comprising allowing the composition to cure with time.

Embodiment 26 provides the method of any one of Embodiments 24-25, wherein the curing occurs at least in part downhole.

Embodiment 27 provides the method of any one of Embodiments 24-26, wherein the curing occurs at least in part before the placement of the composition in the subterranean formation.

Embodiment 28 provides the method of any one of Embodiments 24-27, wherein curing occurs, at least in part, at least one of during and after the placement of the composition in the subterranean formation.

Embodiment 29 provides the method of any one of Embodiments 1-28, wherein the POSS is a partially- or fully-caged POSS.

Embodiment 30 provides the method of any one of Embodiments 1-29, wherein the POSS comprises at least three faces, each face having a different plane.

Embodiment 31 provides the method of any one of Embodiments 1-30, wherein each corner of the polyhedron is occupied by a silicon atom, and each edge of the polyhedron is formed by an Si—O—Si unit.

Embodiment 32 provides the method of any one of Embodiments 1-31, wherein the curable group at each occurrence is independently selected from oxirane, isocyanate, (C₂-C₈)alkynyl, (C₂-C₈)alkenyl, ethylenyl, and aldehyde.

Embodiment 33 provides the method of any one of Embodiments 1-32, wherein the curing group at each occurrence is independently selected from the group consisting of —NH₂, —NHR⁵, —SH, and —OH, wherein R⁵ is a C₁-C₈ hydrocarbyl.

Embodiment 34 provides the method of any one of Embodiments 1-33, wherein the curing group at each occurrence is independently selected from the group consisting of —C(O)—OH, —S(O)(O)—OH, and —P(O)(OH)₂

Embodiment 35 provides the method of any one of Embodiments 1-34, wherein the POSS has the average unit formula [R¹SiO₃₁₂], wherein

R¹ at each occurrence is independently selected from the group consisting of —R², -L-R², and -L-R³—R⁴,

R² at each occurrence is independently selected from the group consisting of (C₁-C₃₀)hydrocarbyl, (C₁-C₃₀)hydrocarbylene-CG, and -CG, wherein each (C₁-C₃₀)hydrocarbyl and (C₁-C₃₀)hydrocarbylene is independently substituted or unsubstituted and is interrupted or terminated by 0, 1, 2, or 3 substituted or unsubstituted S, O, P, or N atoms,

R³ at each occurrence is independently —((C₂-C₈)alkyloxy)ₙ- wherein each alkyl group is independently substituted or unsubstituted and n is about 1 to about 1,000,

R⁴ at each occurrence is independently selected from the group consisting of —H and R²,

L at each occurrence is independently selected from a bond, —O—, —O—SiR¹₂—, —(O—SiR¹₂)ₘ—, —O—SiR¹₂—O—, wherein m is about 2 to about 1,000, and wherein at least one R¹ comprises CG, the at least one curable group or curing group.

Embodiment 36 provides the method of Embodiment 35, wherein the POSS has a total number of [R¹SiO_{3/2}] units selected from the group consisting of 6, 7, 8, 9, 10, 11, and 12.

Embodiment 37 provides the method of any one of Embodiments 35-36, wherein the POSS has a structure selected from the group consisting of

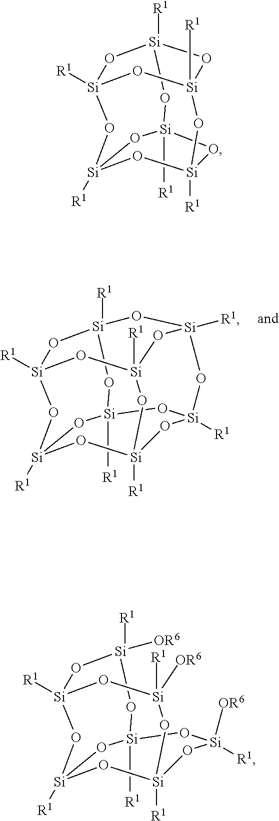

wherein at each occurrence R⁶ is independently selected from the group consisting of —H and R¹.

Embodiment 38 provides the method of any one of Embodiments 35-37, wherein at least one L is —O—.

Embodiment 39 provides the method of any one of Embodiments 35-38, wherein at least one L is —OSi((C₁-C₅)alkyl)₂-.

Embodiment 40 provides the method of any one of Embodiments 35-39, wherein at least one L is —OSi(CH₃)₂—.

Embodiment 41 provides the method of any one of Embodiments 35-40, wherein at least one R² is (C₁-C₃₀)alkyl interrupted or terminated by 0, 1, 2, or 3 substituted or unsubstituted S, O, P, or N atoms.

Embodiment 42 provides the method of any one of Embodiments 35-41, wherein at least one R² is (C₁-C₈)alkyl-CG.

Embodiment 43 provides the method of any one of Embodiments 35-42, wherein at least one R² is (C₁-C₈)alkyl.

Embodiment 44 provides the method of any one of Embodiments 35-43, wherein at least one R² is -CG.

Embodiment 45 provides the method of any one of Embodiments 35-44, wherein at least one R³ is -(ethyleneoxy)ₙ- wherein n is about 1 to about 50.

Embodiment 46 provides the method of any one of Embodiments 35-45, wherein at least one R¹ is —(C₁-C₈)alkyl.

Embodiment 47 provides the method of any one of Embodiments 35-46, wherein at least one R¹ is —(C₁-C₈)alkyl-CG.

Embodiment 48 provides the method of any one of Embodiments 35-47, wherein at least one R¹ is —(C₁-C₈)alkyloxy(C₁-C₁₀)alkyl-CG.

Embodiment 49 provides the method of any one of Embodiments 35-48, wherein at least one R¹ is —(C₁-C₈)alkyloxy(C₁-C₁₀)alkyloxirane.

Embodiment 50 provides the method of any one of Embodiments 35-49, wherein at least one R¹ is —O—Si(CH₃)₂(C₁-C₈)alkyloxy(C₁-C₁₀)alkyl-CG.

Embodiment 51 provides the method of any one of Embodiments 35-50, wherein at least one R¹ is —O—Si(CH₃)₂(C₁-C₈)alkyloxy(C₁-C₁₀)alkyloxirane.

Embodiment 52 provides the method of any one of Embodiments 35-51, wherein at least one R¹ is —O-(ethyleneoxy)ₘ-(C₁-C₁₀)alkyl-CG m is 1 to 1,000.

Embodiment 53 provides the method of any one of Embodiments 35-52, wherein at least one R¹ is —O-(ethyleneoxy)ₘ-(C₁-C₁₀)alkyloxirane m is 1 to 50.

Embodiment 54 provides the method of any one of Embodiments 35-53, wherein at least one R¹ is —O—Si(CH₃)₂—(CH₂)₃—O-glycidyl.

Embodiment 55 provides the method of any one of Embodiments 35-54, wherein at least one R¹ is —O—Si(CH₃)₂—(CH₂)₂-epoxycyclohexyl.

Embodiment 56 provides the method of any one of Embodiments 1-55, wherein the curably reactive agent is about 0.001 wt % to about 50 wt % of the curable composition.

Embodiment 57 provides the method of any one of Embodiments 1-56, wherein the curably reactive agent is about 0.01 wt % to about 30 wt % of the curable composition.

Embodiment 58 provides the method of any one of Embodiments 1-57, wherein the POSS comprises curing groups, wherein the curably reactive agent is a curable agent.

Embodiment 59 provides the method of Embodiment 58, wherein the curable agent is a urethane, a natural resin, an epoxy-based resin, a furan-based resin, an aldehyde resin, bisphenol A diglycidyl ether resin, butoxymethyl butyl glycidyl ether resin, bisphenol A-epichlorohydrin resin, a bisphenol F resin, an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer or derivative thereof, an acrylic acid/acrylamidomethylpropane sulfonate copolymer, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, an epoxide, or furfuraldehyde.

Embodiment 60 provides the method of any one of Embodiments 58-59, wherein the curable agent is about 0.001 wt % to about 50 wt % of the curable composition.

Embodiment 61 provides the method of any one of Embodiments 58-60, wherein the curable agent is about 0.01 wt % to about 30 wt % of the curable composition.

Embodiment 62 provides the method of any one of Embodiments 1-61, wherein the POSS comprises curable groups, wherein the curably reactive agent is a curing agent.

Embodiment 63 provides the method of Embodiment 62, wherein the curing agent is at least one of an amine, an aromatic amine, an aliphatic amine, a cyclo-aliphatic amine, a polyamine, a polyimine, a polyacid, a (C₃-C₆₀)dicarboxylic acid, a (C₃-C₆₀)tricarboxylic acid, a (C₃-C₆₀)fatty acid, a fatty acid derivative, maleic anhydride, a maleic anhydride derivative, acrylic acid, an acrylic acid derivative, piperidine, triethylamine, benzyldimethylamine, N,N-dimethylaminopyridine, 2-(N,N-dimethylaminomethyl)phenol, tris(dimethylaminomethyl)phenol, N-2-(aminoethyl)-3-aminopropyltrimethoxysilane, 3-glycidoxypropyltrimethoxysilane, n-beta-(aminoethyl)-gamma-aminopropyl trimethoxysilane, and n-beta-(aminoethyl)-gamma-aminopropyl trimethoxysilane.

Embodiment 64 provides the method of any one of Embodiments 62-63, wherein the curing agent comprises about 0.001 wt % to about 50 wt % of the curable composition.

Embodiment 65 provides the method of any one of Embodiments 62-64, wherein the curing agent comprises about 0.01 wt % to about 20 wt % of the curable composition.

Embodiment 66 provides the method of any one of Embodiments 1-65, wherein the composition further comprises a catalyst or an accelerator.

Embodiment 67 provides the method of Embodiment 66, wherein the catalyst or accelerator comprises a base.

Embodiment 68 provides the method of any one of Embodiments 66-67, wherein about 0.001 wt % to about 5 wt % of the composition is the catalyst or accelerator.

Embodiment 69 provides the method of any one of Embodiments 1-68, wherein the composition further comprises at least one tackifier.

Embodiment 70 provides the method of Embodiment 69, wherein the tackifier comprises at least one of a shellac, a polyamide, a silyl-modified polyamide, a polyester, a polycarbonate, a polycarbamate, a urethane, a natural resin, an epoxy-based resin, a furan-based resin, a phenolic-based resin, a urea-aldehyde resin, a phenol/phenol formaldehyde/furfuryl alcohol resin, bisphenol A diglycidyl ether resin, butoxymethyl butyl glycidyl ether resin, bisphenol A-epichlorohydrin resin, bisphenol F resin, an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer or derivative thereof, an acrylic acid/acrylamidomethylpropane sulfonate copolymer, a trimer acid, a fatty acid, a fatty acid-derivative, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, citric acid, an epoxide, furfuraldehyde, an aldehyde condensate, a silyl-modified polyamide, a condensation reaction product of a polyacid and a polyamine, and a hydrophobically-modified amine-containing polymer.

Embodiment 71 provides the method of any one of Embodiments 69-70, wherein the tackifier is about 0.001 wt % to about 50 wt % of the composition.

Embodiment 72 provides the method of any one of Embodiments 69-71, wherein the tackifier is about 0.01 wt % to about 30 wt % of the composition.

Embodiment 73 provides the method of any one of Embodiments 1-72, wherein the composition further comprises a second curing agent.

Embodiment 74 provides the method of Embodiment 73, wherein the second curing agent comprises at least one of an amine, an aromatic amine, an aliphatic amine, a cyclo-aliphatic amine, polyamines, amides, polyamides, piperidine, triethylamine, benzyldimethylamine, N,N-dimethylaminopyridine, 2-(N,N-dimethylaminomethyl)phenol, tris(dimethylaminomethyl)phenol, N-2-(aminoethyl)-3-aminopropyltrimethoxysilane, 3-glycidoxypropyltrimethoxysilane, n-beta-(aminoethyl)-gamma-aminopropyl trimethoxysilane, n-beta-(aminoethyl)-gamma-aminopropyl trimethoxysilane, piperazine, derivatives of piperazine (e.g., aminoethylpiperazine), pyrrole, imidazole, pyrazole, pyridine, pyrazine, pyrimidine, pyridazine, indolizine, isoindole, indole, indazole, purine, quinolizine, quinoline, isoquinoline, phthalazine, naphthyridine, quinoxaline, quinazoline, carbazole, carbazole, phenanthridine, acridine, phenathroline, phenazine, imidazolidine, phenoxazine, cinnoline, pyrrolidine, pyrroline, imidazoline, piperidine, indoline, isoindoline, quinuclindine, morpholine, azocine, azepine, azepine, 1,3,5-triazine, thiazole, pteridine, dihydroquinoline, hexa methylene imine, indazole, polyamines, amides, polyamides, 2-ethyl-4-methyl imidazole, and 1,1,3-trichlorotrifluoroacetone.

Embodiment 75 provides the method of any one of Embodiments 73-74, wherein the second curing agent is about 0.001 wt % to about 50 wt % of the composition.

Embodiment 76 provides the method of any one of Embodiments 73-75, wherein the second curing agent is about 0.01 wt % to about 20 wt % of the composition.

Embodiment 77 provides the method of any one of Embodiments 1-76, wherein the composition further comprises a carrier fluid.

Embodiment 78 provides the method of Embodiment 77, wherein the carrier fluid comprises at least one of an aqueous liquid, an organic liquid, and an oil.

Embodiment 79 provides the method of any one of Embodiments 77-78, wherein the carrier fluid is about 5 wt % to about 95 wt % of the composition.

Embodiment 80 provides the method of any one of Embodiments 77-79, wherein the carrier fluid is about 20 wt % to about 70 wt % of the composition.

Embodiment 81 provides the method of any one of Embodiments 1-80, wherein the composition further comprises a silane coupling agent.

Embodiment 82 provides the method of Embodiment 81, wherein the silane coupling agent is a hydrocarbyl-substituted trimethoxysilane, wherein the hydrocarbyl group is substituted or unsubstituted.

Embodiment 83 provides the method of any one of Embodiments 81-82, wherein the silane coupling agent is at least one of N-2-(aminoethyl)-3-aminopropyltrimethoxysilane, 3-glycidoxypropyltrimethoxysilane and n-beta-(aminoethyl)-gamma-aminopropyltrimethoxysilane.

Embodiment 84 provides the method of any one of Embodiments 81-83, wherein about 0.001 wt % to about 20 wt % of the composition is the silane coupling agent.

Embodiment 85 provides the method of any one of Embodiments 81-84, wherein about 0.001 wt % to about 3 wt % of the composition is the silane coupling agent.

Embodiment 86 provides the method of any one of Embodiments 1-85, wherein the composition further comprises a surfactant.

Embodiment 87 provides the method of Embodiment 86, wherein the surfactant comprises at least one of a cationic surfactant, an anionic surfactant, and non-ionic surfactant.

Embodiment 88 provides the method of any one of Embodiments 86-87, wherein the surfactant comprises at least one of ethoxylated nonyl phenol phosphate ester, a cationic surfactant, a C₁₂-C₂₂ alkyl phosphonate, and a mixture of a non-ionic surfactant and an alkyl phosphonate surfactant.

Embodiment 89 provides the method of any one of Embodiments 86-88, wherein about 0.01 wt % to about 50 wt % of the composition is the surfactant.

Embodiment 90 provides the method of any one of Embodiments 86-89, wherein about 0.1 wt % to about 10 wt % of the composition is the surfactant.

Embodiment 91 provides the method of any one of Embodiments 1-90, wherein the composition further comprises a hydrolyzable ester.

Embodiment 92 provides the method of Embodiment 91, wherein the hydrolyzable ester comprises a C₁-C₅ mono-, di-, tri-, or tetra-alkyl ester of a C₂-C₄₀ mono-, di-, tri-, or tetra-carboxylic acid.

Embodiment 93 provides the method of any one of Embodiments 91-92, wherein the hydrolyzable ester comprises at least one of dimethylglutarate, dimethyladipate, dimethylsuccinate, sorbitol, catechol, dimethylthiolate, methyl salicylate, dimethylsalicylate, tert-butylhydroperoxide, and butyl lactate.

Embodiment 94 provides the method of any one of Embodiments 91-93, wherein about 0.01 wt % to about 20 wt % of the composition is the hydrolyzable ester.

Embodiment 95 provides the method of any one of Embodiments 91-94, wherein about 0.1 wt % to about 5 wt % of the composition is the hydrolyzable ester.

Embodiment 96 provides the method of any one of Embodiments 1-95, further comprising combining the composition with an aqueous or oil-based fluid comprising a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof, to form a mixture, wherein the placing the composition in the subterranean formation comprises placing the mixture in the subterranean formation.

Embodiment 97 provides the method of Embodiment 96, wherein the cementing fluid comprises Portland cement, pozzolana cement, gypsum cement, high alumina content cement, slag cement, silica cement, or a combination thereof.

Embodiment 98 provides the method of any one of Embodiments 1-97, wherein at least one of prior to, during, and after the placing of the composition in the subterranean formation, the composition is used downhole, at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof.

Embodiment 99 provides the method of any one of Embodiments 1-98, wherein the composition further comprises water, saline, aqueous base, oil, organic solvent, synthetic fluid oil phase, aqueous solution, alcohol or polyol, cellulose, starch, alkalinity control agent, acidity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, corrosion inhibitor, gas, weight reducing additive, heavy-weight additive, lost circulation material, filtration control additive, salt, fiber, thixotropic additive, breaker, crosslinker, gas, rheology modifier, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement, fly ash, metakaolin, shale, zeolite, a crystalline silica compound, amorphous silica, fibers, a hydratable clay, microspheres, pozzolan lime, or a combination thereof.

Embodiment 100 provides a system for performing the method of any one of Embodiments 1-99, comprising:

a tubular disposed in a wellbore; and

a pump configured to pump the curable composition downhole.

Embodiment 101 provides a system formed by the method of any one of Embodiments 1-100, comprising: a subterranean formation comprising a cured product of the curable composition therein.

Embodiment 102 provides a system formed by the method of any one of Embodiments 1-101, comprising: a subterranean formation comprising the curable composition therein.

Embodiment 103 provides the system of Embodiment 102, further comprising a drillstring disposed in a wellbore, the drillstring comprising a drill bit at a downhole end of the drillstring; an annulus between the drillstring and the wellbore; and a pump configured to pump the composition through the drill string and through the drill bit.

Embodiment 104 provides the system of Embodiment 103, wherein the pump circulates the composition back above-surface through the annulus, the method further comprising a fluid processing unit configured to process the composition exiting the annulus to generate a cleaned drilling fluid for recirculation through the wellbore.

Embodiment 105 provides the method of any one of Embodiments 1-104, wherein the placing of the composition in the subterranean formation downhole comprises pumping the composition through a drill string disposed in a wellbore and through a drill bit at a downhole end of the drill string.

Embodiment 106 provides the method of Embodiment 105, further comprising circulating the composition back above-surface through an annulus and processing the composition exiting the annulus with at least one fluid processing unit to generate a cleaned composition and recirculating the cleaned composition through the wellbore.

Embodiment 107 provides a method of treating a subterranean formation, the method comprising:
obtaining or providing a curable composition comprising
   a polyhedral oligomeric silsesquioxane (POSS) comprising at least one curable group, the POSS having a structure selected from the group consisting of

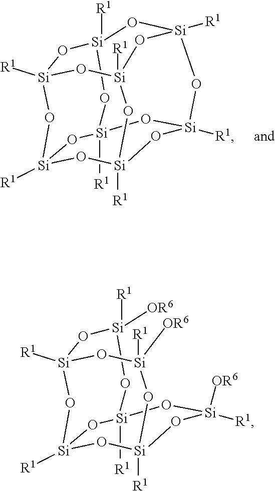

wherein
   R¹ at each occurrence is independently selected from the group consisting of —R², -L-R², and -L-R³—R⁴,
   R² at each occurrence is independently selected from the group consisting of (C₁-C₃₀)hydrocarbyl, (C₁-C₃₀)hydrocarbylene-CG, and -CG, wherein each (C₁-C₃₀)hydrocarbyl and (C₁-C₃₀)hydrocarbylene is independently substituted or unsubstituted and is interrupted or terminated by 0, 1, 2, or 3 S or O atoms,
   R³ at each occurrence is independently -(ethyleneoxy)ₙ- wherein n is about 1 to about 50,
   R⁴ at each occurrence is independently selected from the group consisting of —H and R²,
   L at each occurrence is independently selected from a bond, —O—, —O—SiR¹₂—, —(O—SiR¹₂)ₘ—, —O—SiR¹₂—O—, wherein m is about 2 to about 1,000,
   at each occurrence R⁶ is independently selected from the group consisting of —H and R¹, and
   wherein at least one R¹ comprises CG, the at least one curable group, wherein the at least one curable group is selected from the group consisting of oxirane, isocyanate, (C₂-C₈)alkynyl, (C₂-C₈)alkenyl, ethylenyl, and aldehyde; and
a curing agent curably reactive with the curable groups;
placing the composition in a subterranean formation downhole; and allowing the composition to cure.

Embodiment 108 provides a curable composition for treatment of a subterranean formation, the composition comprising: a polyhedral oligomeric silsesquioxane (POSS) comprising at least one curable or curing group; and an agent curably reactive with the curable or curing groups.

Embodiment 109 provides a cured product of the curable composition of Embodiment 108.

Embodiment 110 provides a method of preparing a composition for treatment of a subterranean formation, the method comprising:

forming a curable composition comprising
a polyhedral oligomeric silsesquioxane (POSS) comprising at least one curable or curing group; and
an agent curably reactive with the curable or curing groups.

Embodiment 111 provides the composition, apparatus, method, or system of any one or any combination of Embodiments 1-110 optionally configured such that all elements or options recited are available to use or select from.

1-110. (canceled)

111. A method of treating a subterranean formation, the method comprising:
placing in the subterranean formation a curable composition comprising
a polyhedral oligomeric silsesquioxane (POSS) comprising at least one curable or curing group; and
an agent curably reactive with the curable or curing groups.

112. The method of claim 111, wherein the composition further comprises at least one of proppant and gravel.

113. The method of claim 111, further comprising fracturing the subterranean formation to form at least one fracture in the subterranean formation.

114. The method of claim 111, wherein the composition further comprises proppant or gravel having coated thereon the agent curably reactive with the curable or curing groups.

115. The method of claim 111, further comprising allowing the composition to at least partially cure.

116. The method of claim 111, wherein the curable group at each occurrence is independently selected from oxirane, isocyanate, (C₂-C₈)alkynyl, (C₂-C₈)alkenyl, ethylenyl, and aldehyde.

117. The method of claim 111, wherein the curing group at each occurrence is independently selected from the group consisting of —NH₂, —NHR⁵, —SH, —OH, —C(O)—OH, —S(O)(O)—OH, and —P(O)(OH)₂, wherein R′ is a C₁-C₈ hydrocarbyl.

118. The method of claim 111, wherein the POSS has the average unit formula [R¹SiO_{3/2}], wherein
R¹ at each occurrence is independently selected from the group consisting of —R², -L-R², and -L-R³—R⁴,
R² at each occurrence is independently selected from the group consisting of (C₁-C₃₀)hydrocarbyl, (C₁-C₃₀)hydrocarbylene-CG, and -CG, wherein each (C₁-C₃₀)hydrocarbyl and (C₁-C₃₀)hydrocarbylene is independently substituted or unsubstituted and is interrupted or terminated by 0, 1, 2, or 3 substituted or unsubstituted S, O, P, or N atoms,
R³ at each occurrence is independently —((C₂-C₈)alkyloxy)ₙ- wherein each alkyl group is independently substituted or unsubstituted and n is about 1 to about 1,000,
R⁴ at each occurrence is independently selected from the group consisting of —H and R²,
L at each occurrence is independently selected from a bond, —O—, —O—SiR¹₂—, —(O—SiR¹₂)ₘ—, —O—SiR¹₂—O—, wherein m is about 2 to about 1,000, and
wherein at least one R¹ comprises CG, the at least one curable group or curing group.

119. The method of claim 118, wherein the POSS has a structure selected from the group consisting of 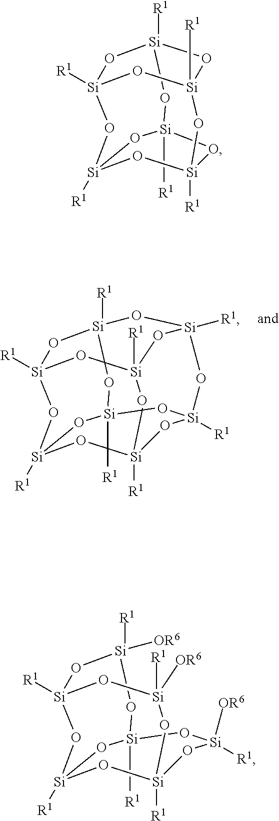
wherein at each occurrence R⁶ is independently selected from the group consisting of —H and R¹.

120. The method of claim 118, wherein at least one L is selected from the group consisting of —O— and —OSi((C₁-C₅)alkyl)₂-.

121. The method of claim 118, wherein at least one R² is selected from the group consisting of (C₁-C₃₀)alkyl interrupted or terminated by 0, 1, 2, or 3 substituted or unsubstituted S, O, P, or N atoms, (C₁-C₈)alkyl-CG, and -CG.

122. The method of claim 118, wherein at least one R³ is -(ethyleneoxy)ₙ- wherein n is about 1 to about 50.

123. The method of claim 118, wherein at least one R¹ is selected from the group consisting of —(C₁-C₈)alkyl, —(C₁-C₈)alkyl-CG, —(C₁-C₈)alkyloxy(C₁-C₁₀)alkyl-CH, —O—Si(CH₃)₂(C₁-C₈)alkyloxy(C₁-C₁₀)alkyl-CG, —O-(ethyleneoxy)ₘ-(C₁-C₁₀)alkyl-CG wherein m is 1 to 1,000, —O—Si(CH₃)₂—(CH₂)₃—O-glycidyl, and —O—Si(CH₃)₂—(CH₂)₂-epoxycyclohexyl.

124. The method of claim 111, wherein the POSS comprises curing groups, wherein the curably reactive agent is a curable agent, wherein the curable agent is a urethane, a natural resin, an epoxy-based resin, a furan-based resin, an aldehyde resin, bisphenol A diglycidyl ether resin, butoxymethyl butyl glycidyl ether resin, bisphenol A-epichlorohydrin resin, a bisphenol F resin, an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer or derivative thereof an acrylic acid/acrylamidomethylpropane sulfonate copolymer, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, an epoxide, or furfuraldehyde.

125. The method of claim 111, wherein the POSS comprises curable groups, wherein the curably reactive agent is a curing agent, wherein the curing agent is at least one of an amine, an aromatic amine, an aliphatic amine, a cyclo-aliphatic amine, a polyamine, a polyimine, a polyacid, a (C₃-C₆₀)dicarboxylic acid, a (C₃-C₆₀)tricarboxylic acid, a (C₃-C₆₀)fatty acid, a fatty acid derivative, maleic anhydride, a maleic anhydride derivative, acrylic acid, an acrylic acid derivative, piperidine, triethylamine, benzyldimethylamine, N,N-dimethylaminopyridine, 2-(N,N-dimethylaminomethyl)phenol, tris(dimethylaminomethyl)phenol, N-2-(aminoethyl)-3-aminopropyltrimethoxysilane, 3-glycidoxypropyltrimethoxysilane, n-beta-(aminoethyl)-gamma-aminopropyl trimethoxysilane, and n-beta-(aminoethyl)-gamma-aminopropyl trimethoxysilane.

126. The method of claim 111, wherein the composition further comprises a catalyst, an accelerator, a tackifier, a second curing agent, a carrier fluid, a silane coupling agent, a surfactant, a hydrolyzable ester, or a combination thereof.

127. A system for performing the method of claim 111, comprising:
a tubular disposed in a wellbore; and
a pump configured to pump the curable composition downhole.

128. A method of treating a subterranean formation, the method comprising:
placing in the subterranean formation a curable composition comprising
a polyhedral oligomeric silsesquioxane (POSS) comprising at least one curable group, the POSS having a structure selected from the group consisting of 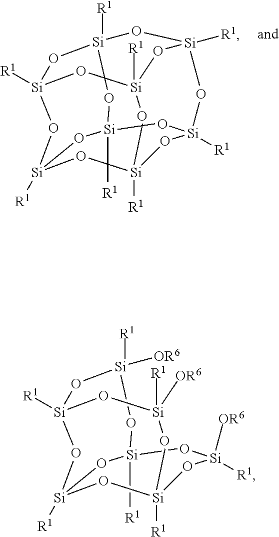
wherein
R¹ at each occurrence is independently selected from the group consisting of —R², -L-R², and -L-R³—R⁴,
R² at each occurrence is independently selected from the group consisting of (C₁-C₃₀)hydrocarbyl, (C₁-C₃₀)hydrocarbylene-CG, and -CG, wherein each (C₁-C₃₀)hydrocarbyl and (C₁-C₃₀)hydrocarbylene is independently substituted or unsubstituted and is interrupted or terminated by 0, 1, 2, or 3 S or O atoms,
R³ at each occurrence is independently -(ethyleneoxy)ₙ- wherein n is about 1 to about 50,
R⁴ at each occurrence is independently selected from the group consisting of —H and R²,
L at each occurrence is independently selected from a bond, —O—, —O—SiR¹₂—, —(O—SiR¹₂)ₘ—, —O—SiR¹₂—O—, wherein in is about 2 to about 1,000,
at each occurrence R⁶ is independently selected from group consisting of —H and R¹, and
wherein at least one R′ comprises CG, the at least one curable group, wherein the at least one curable group is selected from the group consisting of oxirane, isocyanate, (C₂-C₈)alkynyl, (C₂-C₈)alkenyl, ethylenyl, and aldehyde; and
a curing agent curably reactive with the curable groups; and
allowing the composition to cure.

129. A curable composition for treatment of a subterranean formation, the composition comprising:
a polyhedral oligomeric silsesquioxane (POSS) comprising at least one curable or curing group; and
an agent curably reactive with the curable or curing groups.

130. A cured product of the curable composition of claim 129.
